(19) United States
(12) Patent Application Publication
(10) Pub. No.: US 2024/0388611 A1
(43) Pub. Date: Nov. 21, 2024

(54) METHOD AND APPARATUS FOR MULTIPLEXING INTERNET PROTOCOL MULTIMEDIA SUBSYSTEM DATA CHANNELS

(71) Applicant: Samsung Electronics Co., Ltd., Gyeonggi-do (KR)

(72) Inventor: Hyunkoo YANG, Gyeonggi-do (KR)

(21) Appl. No.: 18/663,752

(22) Filed: May 14, 2024

(30) Foreign Application Priority Data
May 15, 2023 (KR) 10-2023-0062651
Aug. 7, 2023 (KR) 10-2023-0103075

(51) Int. Cl. H04L 65/1104; H04L 65/1016

(52) U.S. Cl. CPC H04L 65/1104; H04L 65/1016

(57) ABSTRACT

The disclosure relates to a fifth generation (5G) or sixth generation (6G) communication system for supporting a higher data transmission rate. Provided is a method of a user equipment (UE) in a wireless communication system, including transmitting, to a network entity, a first message comprising a session description protocol (SDP) offer, and receiving, from the network entity, a second message comprising an SDP answer corresponding to the SDP offer, wherein the SDP offer comprises a data channel stream identifier of at least one bootstrap data channel and a first attribute related to data channel multiplexing, and wherein the SDP answer comprises access information of the network entity and the first attribute.

### CROSS-REFERENCE TO RELATED APPLICATION(S)

This application is based on and claims priority under 35 U.S.C. § 119 to Korean Patent Application Nos. 10-2023-0062651 and 10-2023-0103075, filed on May 15, 2023, and Aug. 7, 2023, respectively, in the Korean Intellectual Property Office, the entire disclosure of each of which is incorporated herein by reference.

### BACKGROUND

### 1. Field

The disclosure relates generally to wireless communication, and more particularly, to a method and an apparatus for multiplexing Internet protocol multimedia subsystem (IMS) data channels in a wireless communication system.

### 2. Description of Related Art

5th generation (5G) mobile communication technologies define broad frequency bands such that high transmission rates and new services are possible, and can be implemented not only in “Sub 6 GHz” bands such as 3.5 GHz, but also in “Above 6 GHz” bands referred to as millimeter wave (mmWave) including 28 GHz and 39 GHz. In addition, it has been considered to implement 6th generation (6G) mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BW), new channel coding methods such as a Low Density Parity Check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random-access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

Telephony was first invented in the late 19^{th} century, and mobile telephony became popular in the late 20^{th} century. With the development of mobile communication technology, video telephony services that allow people to make calls while watching a video over the communication counterpart have been supported, and it is expected that a 5G mobile communication system will provide a real-time interaction service at a new level including touch and feel through a call with a remote counterpart.

An Internet protocol (IP) multimedia subsystem (IMS) is technology that provides multimedia services such as voice, audio, video, data, and the like, based on IP. The IMS pursues improvement of price competitiveness of services and radio service development and change by using general-purpose Internet-based technology and standardized network functions. The IMS is independent from an access network and promotes global interconnection between services and conversion of wired and wireless networks through interwork between applications of different networks due to improvement of a session management function. The IMS has been discussed for interaction and conversion between different mobile communication systems in a wide code division multiple access (W-CDMA) based on the initial all-IP network, but has expanded to not only a mobile communication system but also technology that supports various integrated wired and wireless networks based on the IP network.

The IMS supports the use of data channels capable of delivering not only a voice and an image but also a random data stream within the same session. The data channels may have transmission requirements such as latency, robustness, bandwidth, and the like according to the usage purpose and characteristics of data to be transmitted, and an IMS operator may configure a data channel in consideration of the requirements. A telephony service provided by an operator may provide global user identification and contact based on a phone number, user authentication, mobility, session control, quality of service (QOS), security, robustness, and the like, and the use of a data channel combined with the telephony service enables a combination of advantages of the telephony service and web technology.

The web application hosted by the Internet can be identified and acquired through a hypertext transport protocol uniform resource locator (HTTP URL). To enable a plurality of users to use a service provided by the same web application, service access information such as a URL may be shared through a separate method that is not provided by the web application. A data channel application using an IMS data channel may be selected by an operator based on call context information, such as a user identifier, and a selected data channel application is distributed to the UE by a data channel server through a special-purpose data channel corresponding to a bootstrap data channel. The UE may transmit a root URL (“/”) request to the bootstrap data channel and download HTML web documents, JavaScript™, images, style sheets, and the like included in the data channel application. To provide real-time interaction service participants with various experiences intended by a service provider, the UE is required to execute one or more data channel applications.

Thus, there is a need in the art for a method and apparatus in which data channel applications may be provided through different data channel servers, and the UE is enabled to efficiently access one or more of the data channel servers.

### SUMMARY

The disclosure has been made to address at least the above-mentioned problems and/or disadvantages and to provide at least the advantages described below.

Accordingly, an aspect of the disclosure is to provide a method of multiplexing IMS data channels in a wireless communication system.

An aspect of the disclosure is to provide an apparatus and a method for establishing multiplexed data channels in a wireless communication system.

An aspect of the disclosure is to provide a method and apparatus enabling a real-time interaction service by providing a data channel application provided from one or more data channel servers to real-time communication service participants.

In accordance with an aspect of the disclosure, a method of a UE in a wireless communication system includes transmitting, to a network entity, a first message comprising a session description protocol (SDP) offer, and receiving, from the network entity, a second message comprising an SDP answer corresponding to the SDP offer, wherein the SDP offer comprises a data channel stream identifier of at least one bootstrap data channel and a first attribute related to data channel multiplexing, and wherein the SDP answer comprises access information of the network entity and the first attribute.

In accordance with an aspect of the disclosure, a method of a network entity in a wireless communication system includes receiving, from a UE, a first message comprising an SDP offer, and transmitting, to the UE, a second message comprising an SDP answer corresponding to the SDP offer, wherein the SDP offer comprises a data channel stream identifier of at least one bootstrap data channel and a first attribute related to data channel multiplexing, and wherein the SDP answer comprises access information of the network entity and the first attribute.

In accordance with an aspect of the disclosure, a UE in a wireless communication system includes a transceiver, and at least one processor connected to the transceiver and configured to transmit, to a network entity, a first message comprising an SDP offer through the transceiver, and receive, from the network entity, a second message comprising an SDP answer corresponding to the SDP offer, wherein the SDP offer comprises a data channel stream identifier of at least one bootstrap data channel and a first attribute related to data channel multiplexing, and wherein the SDP answer comprises access information of the network entity and the first attribute.

In accordance with an aspect of the disclosure, a network entity in a wireless communication system includes a transceiver, and at least one processor connected to the transceiver and configured to receive, from a UE, a first message comprising a session description protocol (SDP) offer through the transceiver, and transmit, to the UE, a second message comprising an SDP answer corresponding to the SDP offer, wherein the SDP offer comprises a data channel stream identifier of at least one bootstrap data channel and a first attribute related to data channel multiplexing, and wherein the SDP answer comprises access information of the network entity and the first attribute.

### BRIEF DESCRIPTION OF THE DRAWINGS

The above and other aspects, features, and advantages of embodiments of the disclosure will be more apparent from the following detailed description taken in conjunction with the accompanying drawings, in which:

FIG. 1 illustrates the web application provision structure according to an embodiment;

FIG. 2 illustrates the IMS network structure according to an embodiment;

FIG. 3 illustrates interaction between the IMS and a 5G core network (5GC) according to an embodiment;

FIG. 4 illustrates a session initiation protocol (SIP) operation procedure in a mobile communication system according to an embodiment;

FIG. 5 illustrates an SDP negotiation procedure of a real-time interaction service in a communication system according to an embodiment;

FIG. 6 illustrates the network structure supporting a data channel function in a communication system according to an embodiment;

FIG. 7 illustrates a UE protocol stack supporting a data channel application in a communication system according to an embodiment;

FIG. 8 illustrates the media plane structure including bootstrap data channels provided by two DCMFs in a communication system according to an embodiment;

FIG. 9 illustrates the media plane structure in which bootstrap data channels provided by two DCMFs are multiplexed in a communication system according to an embodiment;

FIG. 10 illustrates a multiplexed bootstrap data channel establishment procedure in a communication system according to an embodiment;

FIG. 11 illustrates the media plane structure provided by two DCMFs supporting bootstrap data channel multiplexing in a communication system according to an embodiment;

FIG. 12 illustrates a procedure of establishing two bootstrap data channels multiplexed in a communication system according to an embodiment;

FIG. 13 illustrates the media plane structure in which a bootstrap data channel and an application data channel are multiplexed in a communication system according to an embodiment;

FIG. 14 illustrates a procedure of establishing an application data channel multiplexed with a bootstrap data channel in a communication system according to an embodiment;

FIG. 15 illustrates the media plane structure supporting application data channels toward different endpoints (ATDE) multiplexing in a communication system according to an embodiment;

FIG. 16 illustrates an application data channel establishment and data exchange procedure to which ATDE multiplexing is applied in a communication system according to an embodiment;

FIGS. 17A and 17B illustrate negotiation indicating whether to support ATDE multiplexing using the SDP in a communication system according to an embodiment;

FIG. 18 illustrates the internal structure of a network entity in a wireless communication system according to an embodiment; and

FIG. 19 illustrates the internal structure of a UE in a wireless communication system according to an embodiment.

### DETAILED DESCRIPTION

The following description with reference to the accompanying drawings is provided to assist in a comprehensive understanding of embodiments of the present disclosure. Accordingly, those of ordinary skill in the art will recognize that various changes and modifications of the embodiments described herein can be made without departing from the scope and spirit of the present disclosure., Descriptions of well-known functions and constructions may be omitted for the sake of clarity and conciseness.

In the accompanying drawings, some elements may be exaggerated, omitted, or schematically illustrated.

An element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

In the drawings, similar reference numerals may be used to designate similar or relevant elements. It is to be understood that a singular form of a noun corresponding to an item may include one or more of the items unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “a first”, “a second”, “the first”, and “the second” may be used to distinguish a corresponding element from another, and do not limit the elements in importance or order. If a first element is referred to, with or without the term “operatively” or “communicatively”, as “coupled with/to” or “connected with/to” another element (e.g., a second element), this indicates that the first element may be coupled/connected with/to the second element directly (e.g., wiredly), wirelessly, or via a third element.

Herein, a base station (BS) is an entity that allocates resources to terminals, and may be at least one of a gNode B, an eNode B, a Node B, a wireless access unit, a base station controller, and a node on a network. A terminal may include a UE, a mobile station (MS), a cellular phone, a smartphone, a computer, or a multimedia system capable of performing a communication function. Herein, 5G NR or a 5G NR system may be described by way of example, but the embodiments of the disclosure may also be applied to other communication systems having similar technical backgrounds or channel types. Based on determinations by those skilled in the art, the disclosure may be applied to other communication systems through some modifications without significantly departing from the scope of the disclosure.

The disclosure relates to a method and an apparatus for providing a data channel application in a communication system that provides a real-time interaction service.

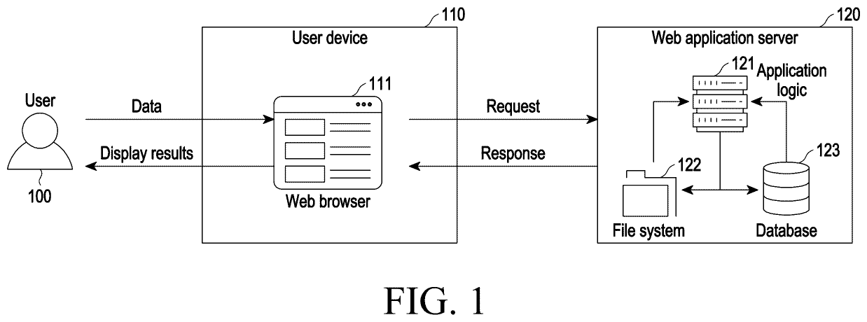

FIG. 1 illustrates an example of the web application provision structure according to an embodiment.

Referring to FIG. 1, a user 100 may consume a web application by using a UE 110. A web browser 111 running in the user device 110 may perform a presentation function of the web application. For example, the web browser 111 may receive an input of data from the user 100, render the user data processing result to a display device or the like, and provide the result to the user 100. Information for the web application presentation of the web browser 111 may include hypertext markup language (HTML), cascading style sheet (CSS), and JavaScript™, and may be downloaded from a web application server 120 by a request through a hypertext transfer protocol (HTTP) uniform resource locator (URL). The HTML may provide the format of the web application, the CSS may control displaying of the web application shown to the user, and the programming language JavaScript™ may provide tools for changing operations of various components included in the web application.

The user data processing may be a procedure in which the web browser 111 transmits a request for data processing to the web application server 120 and receives a response to the data processing from the web application server 120. The web application server 120 may include application logic 121 for processing user data, a file management system 122, and a database 123.

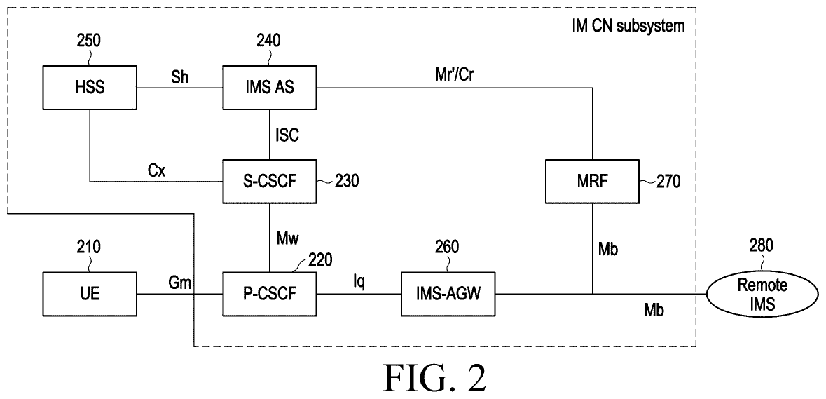

FIG. 2 illustrates the IMS network structure according to an embodiment.

Referring to FIG. 2, a UE 210 may communicate with another UE located in a remote IMS network 280 and an IM CN subsystem component through an IP multimedia core network (IM CN) subsystem. The IM CN subsystem may include a P-CSCF 220, an S-CSCF 230, an IMS AS 240, an HSS 250, an IMS AGW 260, and/or an MRF 270, and the components may perform the following functions.

Proxy call session control function (P-CSCF) 220: the P-CSCF may perform a first contact point function through which the UE may access the IMS.
Serving CSCF (S-CSCF) 230: the S-CSCF may handle a real user session state of the network.
IMS application server (AS) 240: the IMS AS may provide and execute an Internet multimedia (IM) value added service. The IMS AS may affect an SIP session by acting as a proxy for services supported in an operator network.
Home subscriber server (HSS) 250: the HSS may serve as a database that stores information on the user.
IMS-access gateway (AGW) 260: the IMS-AGW may be located at a media transmission path to manage network addresses associated with inbound and outbound media streams.
Media resource function (MRF) 270: the MRF may perform various processing works related to media streams. The MRF may be divided into a multimedia resource function controller (MRFC) performing the control and a multimedia resource function processor (MRFP) performing media processing.
Interrogating/serving CSCF (I-CSCF) 230: the I-CSCF may perform a contact point function for a subscriber of the network operator or a roaming user currently located in a service area of the network operator.

Referring to FIG. 2, interfaces between the components may be expressed as the following reference points.
Gm: the reference point Gm may support communication between the UE and the IM CN subsystem. For example, the UE may make a request for network registration and session control through the reference point Gm. For the reference point Gm, an SIP described below may be used.
Mw: the reference point Mw may support signaling message exchange and transmission between CSCFs.
ISC: the reference point ISC may support information exchange required for services provided by a service platform between the S-CSCF and the service platform (for example, IMS AS).
Sh: the reference point Sh may support information exchange required for services provided by a service platform between the HSS and the service platform (for example, IMS AS).
Cx: the reference point Cx may support information transmission between the HSS and the CSCF.
Mr′/Cr: the reference point Mr′ may support interaction for session control between the IMS AS and the MRFC, and the reference point Cr may support interaction for media control between the IMS AS and the MRFC.
Iq: the reference point Iq may support information exchange required for allocation and release of a transport address between the P-CSCF and the IMS AGW.
Mb: the reference point Mb may support IMS media transmission between the IMS components.

The UE and the IMS network may mutually transfer features and capabilities for supporting services in a registration or session establishment process. For example, the UE may indicate that the UE supports data channels by using a media feature tag +sip.app-subtype having a value of “webrtc-datachannel”.

The wireless communication system herein may be a 5GS. The 5G system may include a 5G radio access network (next generation radio access network (NG-RAN) and a 5GC. The 5GS may interwork with the existing LTE and may be connected to non-third generation partnership project (non-3GPP) radio access technology such as wireless fidelity (Wi-Fi). The 5GC may be between the NG-RAN and an external packet data network (public data network (PDN)) and may provide the user with various types of data services including a voice. Elements of a control plane of the 5GC may be considered as virtualized network functions (VNFs), and communication between the VNFs may be considered that one VNF provides services to other VNFs through exchange of a RESTful-based application programming interface (API). The API-based communication interface between VNFs is referred to as a service-based interface (SBI).

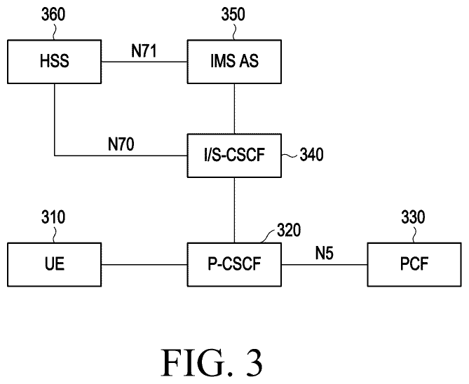

FIG. 3 illustrates an example of interaction between the IMS and the 5GC according to an embodiment.

Referring to FIG. 3, a P-CSCF 320 supporting the SBI may communicate with a policy control function (PCF) 330, which may be indicated as reference point N5. The PCF 330 may support establishment and distribution of a policy for managing a network operation, and the P-CSCF 320 supporting the SBI may be considered as an application function (AF) that uses a service which the PCF 330 provides to another VNF.

An HSS 360 supporting the SBI may communicate with an I/S-CSCF 340 supporting the SBI through reference point N70 and communicate with an IMS AS 350 supporting the SBI through a reference point N71. Similarly, the I/S-CSCF 340 supporting the SBI and the IMS AS 350 supporting the SBI may be considered as AFs that use a service provided by the HSS 360 supporting the SBI, and functions provided to the reference points N70 and N71 may be equivalent to the functions provided to reference points Cx and Sh, respectively.

The SIP is a signaling protocol of an application layer that specifies a procedure in which intelligent UEs which desire to communicate on the Internet identify each other, find their locations, and generate or delete/change a multimedia communication session between each other. The SIP is a request/response format that controls the generation, modification, and end of the multimedia service session such as an Internet-based meeting, a phone call, a voice mail, an event notification, instant messaging, or the like, and may be used for all of a TCP and a user datagram protocol (UDP). By using an SIP URL similar to an email address to distinguish respective users, the service is provided without dependence on an IP address. Since the SIP is based on text developed using many parts of the HTTP and the SMTP, the SIP is seamlessly implemented and has the flexibility and scalability to generate various services by combining with many other protocols used on the Internet.

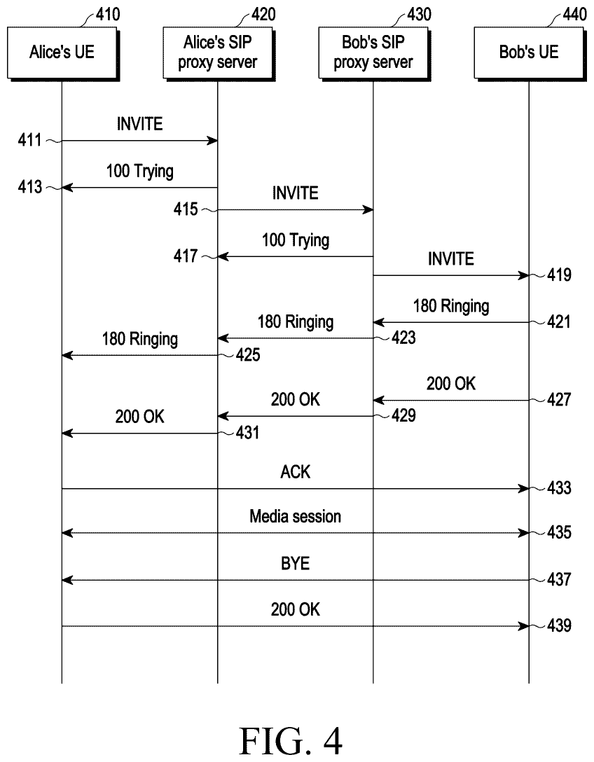

FIG. 4 illustrates an SIP operation procedure in a mobile communication system according to an embodiment.

Referring to FIG. 4, a user Alice have a call with Bob's UE (SIP UE) 440 by using her own UE (SIP UI) 410, and the following communication procedure may be performed between an Alice's SIP proxy server 420 and user Bob's SIP proxy server 430 to establish a communication session.

In step 411, Alice's UE 410 transmits an SIP INVITE request including an SDP offer described below to Alice's proxy server 420. The SIP INVITE may include a caller (Alice)'s SIP URI, a recipient (Bob)'s SIP URI, and information for establishing a communication session.

In step 413, Alice's proxy server 420 receives the SIP INVITE request transmitted in step 411 and transmits a 100 Trying response to Alice's UE 410. The 100 Trying response indicates that the INVITE has been received and Alice's proxy server 420 is operating to transfer the INVITE request to the recipient (Bob).

In step 415, Alice's proxy server 420 identifies a network address of Bob's proxy server 430 through a method such as a domain name service (DNS) or the like and transmits the SIP INVITE to Bob's proxy server 430. Alice's proxy server 420 may add a network address of Alice's proxy server 420 to a Via head field of the SIP INVITE to be transmitted to Bob's proxy server 430.

In step 417, Bob's proxy server 430 receives the SIP INVITE and transmits the 100 Trying to Alice's proxy server 420 to indicate that Bob's proxy server 430 has received the SIP INVITE and is processing a request.

In step 419, Bob's proxy server 430 identifies a network address of Bob's UE 440 by using a database and transmits the SIP INVITE to Bob's UE 440. Bob's proxy server 430 may add the network address of Bob's proxy server 430 to a Via head field of the SIP INVITE to be transmitted to Bob's UE 440.

In step 421, Bob's UE 440 receives the INVITE and informs Bob that a request for a call is received from Alice through a sound, vibration, screen, or the like. Bob's UE 440 informs Bob's proxy server 430 that the operation is being performed through a 180 Ringing response. The network address of Bob's proxy server 430 may be detected by the information added to the Via head field in step 419.

In step 423, Bob's proxy server 430 transfers the received 180 Ringing response to Alice's proxy server 420. The network address of Alice's proxy server 430 may be detected by the information added to the Via head field in step 415.

In step 425, Alice's proxy server 420 transfers the received 180 Ringing response to Alice's UE 410. Alice's UE 410 receiving the 180 Ringing response may inform Alice of the reception through a ring-back tone.

In step 427, when Bob determines to receive this call, Bob's UE 440 informs Bob's proxy server 430 that the call is received through a 200 OK response including an SDF Answer described below. As a result, the SDP is transferred from Alice's UE 410 to Bob's UE 440 and then again from Bob's UE 440 to Alice's UE 410, which corresponds to a media capability negotiation using an SDP offer/answer described below. The 200 OK response may include a network address that can directly communicate with Bob's UE 440 in a Contact header field.

In step 429, Bob's proxy server 430 transfers the received 200 OK response to Alice's proxy server 420. The network address of Alice's proxy server 430 may be detected by the information added to the Via head field in step 415.

In step 431, Alice's proxy server 420 transfers the received 200 OK response to Alice's UE 410. Alice's UE 410 receiving the 200 OK response may stop the call-back tone and inform Alice that the call is received.

In step 433, Alice's UE 410 transmits an ACK message informing that a final response (200 OK) is received to Bob's UE 440. The ACK message may be transmitted to Bob's UE 440 without passing through Alice's proxy server 420 and Bob's proxy server 430, by using the network address of Bob's UE 440 included in the Contact header field in step 427.

In step 435, a handshake procedure including INVITE/200/ACK has finished and a media session starts. Alice or Bob may change a characteristic of a media session during the media session, which may be performed through re-INVITE/200/ACK handshake including an SDP offer that reflects the changed characteristic of the media session.

In step 437, when Bob first ends the call, Bob's UE 440 transmits a BYE message to Alice's UE 410.

In step 439, Alice's UE receiving the BYE message transmits a 200 OK response to Bob's UE 440 informing of reception of the BYE message and ends the communication session.

The SIP INVITE request transmitted by Alice's UE 410 in step 411 of FIG. 4 may include feature and capability information for supporting a service. In step 413 of FIG. 4, Alice's proxy server 420 may determine whether to support the features and capabilities included in the SIP INVITE request, based on Alice's subscription information and a policy of a network provider, and delete some of the features and capabilities and then transmit the features and capabilities to Bob's proxy server 430 or reject establishment of the call session according to a determination result. In step 417 of FIG. 4, Bob's proxy server 420 may determine whether to support the requested features and capabilities in response to the SIP INVITE request received from Alice's proxy server 420, based on Bob's subscription information and a policy of a network provider, and delete some of the features and capabilities and then transmit the features and capabilities to Bob's UE 440 or reject establishment of the call session according to a determination result.

The SDP included in the SIP message in step 411 and step 427 of FIG. 4 is described as an example. The SDP is a protocol based on an American standard code for information interchange (ASCII) string for describing a multimedia session and relevant scheduling information. The SDP transmits information on a media stream of a multimedia session to join in the session, and the multimedia session is defined as a media stream for a duration time, and the time the session lasts does not have to be continuous. A multicast-based session on the Internet aims to inform of the existence and time of the session and transmit session participation information, which is the goal in a unicast environment. SDP information content may include a name and a goal of the session, a session progress time, session configuration media, media reception information, and the like.

An SDP description is in a document format and may include a session-level section and the following 0 or more media descriptions. An example of the SDP description is as shown in Table 1 below.

TABLE 1

v=0
o=alice 2819384758 2819384758 IN IP4 198.51.100.1
s=Call to Bob
c=IN IP4 198.51.100.1
t=0 0
m=audio 49170 RTP/AVP 0
m=video 51372 RTP/AVP 99

In Table 1, the SDP description includes a session-level section including “v=” line, “o=” line, “s=” line, “s=” line, and “t=” line and two media descriptions (“m=” line). In the SDP description, the meaning of each line is described below. −“v=” line (version-field): a line indicating a version of the SDP. “v=” line in Table 1 indicates that the SDP version is 0.

“0=” line (origin-field): a line indicating an originator. “o=” line may sequentially include a user name (Username), a session identifier (sess-id), a session version (sess-version), a network type (nettype), a network address type (addtype), and a network address of a session initiation device (unicast-address). “o=” line in Table 1 above indicates that Alice initiates a session having an identifier of 2819384758 and a version of 2819384758 in the Internet (IN) network having an IP4 address of 198.51.100.1.

“s=” line (session-name-field): a line indicating a name of a session including letters. “s=” line in Table 1 above indicates that a name of a session is “Call to Bob”.

“c=” line (connection-field): information required for establishing a network connection. “c=” line may sequentially include a network type (nettype), a network address type (addtype), and a network address (connection-address). “c=” line in Table 1 above indicates to establish a network connection to the IN network having an IP4 address of 198.51.100.1. When a media session is established to another IP address, “c=” line may be configured in units of media descriptions (“m=” line).

“t=” line (time-field): a line indicating a start time point and an end time point of a session. “t=” line in Table 1 above indicates a permanent session.

“m=” line (media-field): one media description may start at “m=” line and end at next “m=” line or the last of the SDP description and may include an additional attribute. “m=” line may sequentially include a media type (media), a transmission port number (port), a transmission protocol identifier (proto), and a media format technology (fmt). First “m=” line in Table 1 above indicates that voice information (audio) is transmitted to an RTP/AVP protocol through port 49170 and a media format (0) is displayed as an additional attribute, and second “m=” line indicates that image information (video) is transmitted to an RTP/AVP protocol through port 51372 and a media format (99) is displayed as an additional attribute. The RTP/AVP is an audio video profile of a real-time transport protocol (RTP).

To provide a real-time interaction service in the communication system according to various embodiments of the disclosure, negotiations for media sessions included in the service should be conducted between UEs of users participating in the service. The communication system herein may agree on the media sessions through the SDP negotiation to provide the service (for example, the real-time interaction service). Hereinafter, it is assumed that the service provided in the communication system is the real-time interaction service, but the disclosure is not limited thereto.

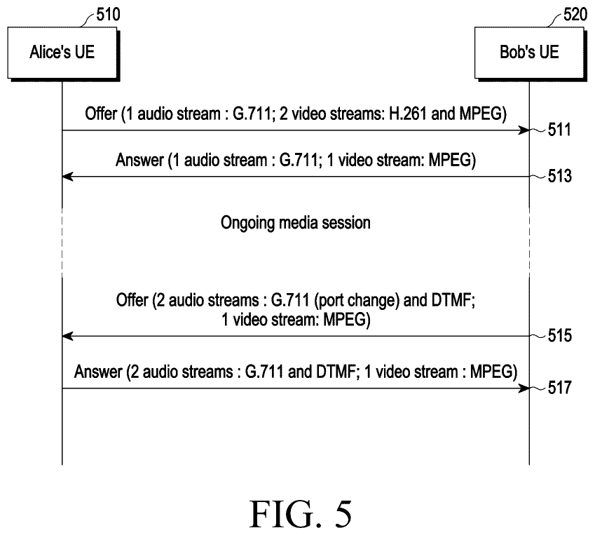

FIG. 5 illustrates an SDP negotiation procedure of a real-time interaction services in a communication system according to an embodiment.

In FIG. 5, it is noted that only the SDP exchange procedure is considered and the SIP operation described above is not included.

Referring to FIG. 5, the SDP negotiation of the real-time interaction service in the communication system herein may be performed according to the following procedure.

In step 511, Alice's UE 510 transmits an SDP offer to Bob's UE 520. Table 2 below shows an example of the SDP offer. Referring to Table 2, Alice proposes media descriptions for three media streams.
Voice stream 1: UDP port 49170, G.711 ulaw codec (G.711)
Video stream 1: UDP port 51372, H.261 codec (payload type 31)
Video stream 2: UDP port 53000, MPEG codec (payload type 32)

TABLE 2

v=0
o=alice 2890844526 2890844526 IN IP4 host.anywhere.com
s=
c=IN IP4 host.anywhere.com
t=0 0
m=audio 49170 RTP/AVP 0
a=rtpmap:0 PCMU/8000
m=video 51372 RTP/AVP 31
a=rtpmap:31 H261/90000
m=video 53000 RTP/AVP 32
a=rtpmap:32 MPV/90000

In step 513, Bob's UE 520 generates an answer to the SDP offer (SDP answer) and transmits the SDP answer to Alice's UE 510. Table 3 below shows an example of the SDP answer. Referring to Table 3, Bob allows media descriptions for three media streams.
Voice stream 1: UDP port 49920, G.711 ulaw codec (G.711)
Video stream 1: open of a video stream using H.261 codec is not required (UDP port is configured as 0 and media attributes (“a=”line) are not defined)
Video stream 2: UDP port 53000, MPEG codec (payload type 32)

TABLE 3

v=0
o=bob 2890844730 2890844730 IN IP4 host.example.com
s=
c=IN IP4 host.example.com
t=0 0
m=audio 49920 RTP/AVP 0
a=rtpmap:0 PCMU/8000
m=video 0 RTP/AVP 31
m=video 53000 RTP/AVP 32
a=rtpmap:32 MPV/90000

In step 515, Bob's UE 520 changes a UDP port number to receive a voice from 49920 to 65422 during a communication session and adds a separate voice stream dedicated for reception to receive an event. Bob's UE 520 generates an SDP offer that reflects the content and transmits the SDP offer to Alice's UE 510. Table 4 below shows an example of the SDP offer. Referring to Table 4, Bob proposes media descriptions for four media streams.
Voice stream 1: change UDP port 49920 to 65422, G.711 ulaw codec (G.711)
Video stream 1: open of a video stream using H.261 codec is not required (UDP port is configured as 0 and media attributes (“a=”line) are not defined)
Video stream 2: UDP port 53000, MPEG codec (payload type 32)
Voice stream 2: UDP port 51434, dual tone multiple frequency (DTMF) event (payload type 110), dedicated for reception (recvonly)

TABLE 4

v=0
o=bob 2890844730 2890844731 IN IP4 host.example.com
s=
c=IN IP4 host.example.com
t=0 0
m=audio 65422 RTP/AVP 0
a=rtpmap:0 PCMU/8000
m=video 0 RTP/AVP 31
m=video 53000 RTP/AVP 32
a=rtpmap:32 MPV/90000
m=audio 51434 RTP/AVP 110
a=rtpmap:110 telephone-events/8000
a=recvonly

In step 517: Alice's UE 510 generates an answer to the SDP offer and transmits the SDP answer to Bob's UE 520. Table 5 below shows an example of the SDP answer. Referring to Table 5, Alice allows media descriptions for four media streams.
Voice stream 1: UDP port 49170, G.711 ulaw codec (G.711)
Video stream 1: not open a video stream using H.261 codec (configure UDP port as 0)
Video stream 2: UDP port 53000, MPEG codec (payload type 32)
Voice stream 2: UDP port 53122, dual tone multiple frequency (DTMF) event (payload type 110), dedicated for transmission (sendonly)

TABLE 5

v=0
o=alice 2890844526 2890844527 IN IP4 host.anywhere.com
s=
c=IN IP4 host.anywhere.com
t=0 0
m=audio 49170 RTP/AVP 0
a=rtpmap:0 PCMU/8000
m=video 0 RTP/AVP 31
a=rtpmap:31 H261/90000
m=video 53000 RTP/AVP 32
a=rtpmap:32 MPV/90000
m=audio 53122 RTP/AVP 110
a=rtpmap:110 telephone-events/8000
a=sendonly

The web application for providing a service (for example, a real-time interaction service) in a communication system herein may be provided from a data channel application server (DCAS). The data channel application server may be located in an IMS operator network or a 3^{rd} party network. the web application provided by the data channel application server may be referred to as a data channel application (DCA). A UE participating in a service (for example, a real-time interaction service) provided by the data channel application may exchange data required by the service through a data channel (DC) with another UE participating in the same service directly or via an intermediate node and may communicate with the data channel application server by using a bootstrap data channel (BDC).

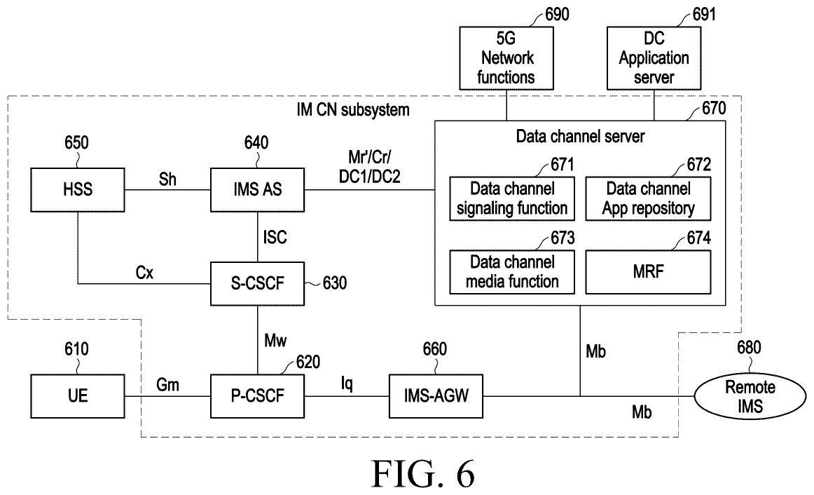

FIG. 6 illustrates a network structure supporting a data channel function in a communication system according to an embodiment.

Referring to FIG. 6, the communication system may include a UE 610 and an IM CN subsystem supporting the data channel function. The UE 610 may communicate with another UE located in a remote IMS network 680 and components of the IM CN subsystem through the IM CN subsystem. The IM CN subsystem may include a P-CSCF 620, an S-CSCF 630, an IMS AS 640, an HSS 650, an IMS AGW 660, and/or a data channel server 670. For the description of the UE 610, the P-CSCF 620, the I/S-CSCF 630, the IMS AS 640, the HSS 650, and the IMS AGW 660 in the communication system of FIG. 6, refer to the description of the UE 210 or 310, the P-CSCF 220 or 320, the I/S-CSCF 230 or 340, the IMS AS 240 or 350, the HSS 250 or 360, the IMS AGW 260, and/or the MRF 270 in FIG. 2 or 3, and overlapping description may be omitted.

The data channel server 670 may include a data channel signaling function (DCSF) 671, a data channel application repository (DCAR) 672, a data channel media function (DCMF) 673, and/or an MRF 674.

The data channel signaling function 671 may manage and controls data channels including a bootstrap data channel, manage data channels and generates/receives events through communication with the IMS AS, manage data channel application and controls distribution, communicate with a 5G network function 690 for providing the data channel application service, and serve as a proxy for distributing resources of the data channel application server 691.

The data channel application (app) repository 672 may store and manage the data channel application and may be located inside or outside the data channel server 670.

The data channel media function 673 and the MRF 674 may manage and control media resources to be transmitted to data channels including a bootstrap data channel, and
serve as a proxy for exchanging data with an endpoint of a data channel connected to the UE and another endpoint,

The data channel media function 673 and the MRF 374 may provide the same function through different interfaces, and an operator may include only one or both of the data channel media function 673 and the MRF 674 in the data channel server 670 in consideration of compatibility with other network equipment and a UE.

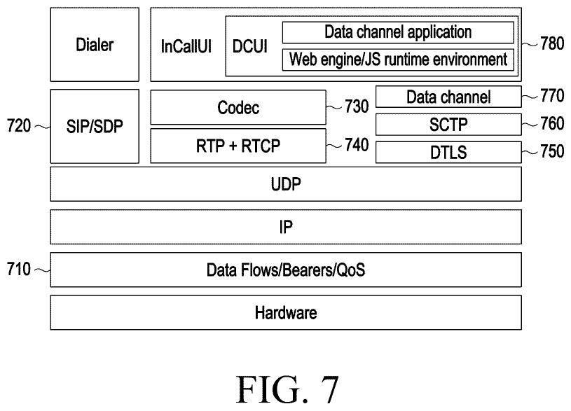

FIG. 7 illustrates a UE protocol stack supporting a data channel application in a communication system according to an embodiment.

Referring to FIG. 7, a data flows/bearers/QOS layer 710 may support a packet processing rule that complies with the relevant standard. An SIP/SDP layer 720 may negotiate a media parameter using the SIP/SDP and control a session. Media data such as videos, speeches, still images, text, and the like may be encoded by a codec layer 730 and transmitted through a packet of an RTP 740 and may use an RTP control protocol (RTCP) 740 to control an RTP session and report a reception environment. A datagram transport layer security (DTLS) layer 750 may initiate establishment of a DTLS session between the UE and the IMS network or UEs, and the DTLS session may provide security for stream control transmission protocol (SCTP) data transmission. The SCTP layer 760 may initiate transport session establishment including SCTP association between the UE and the IMS network or UEs. One SCTP association may include one or more data channels, and each data channel may be identified by a stream ID provided by the SCTP. The data channel layer 770 may perform integrated management on the DTLS layer 750 and the SCTP layer 760, and the data channel application may establish a data channel and provide a JavaScript™ API that can use the established data channel to exchange application data. An InCallUI layer 780 may manage a display and an input device of the UE during a call, and the DCUI refers to functions of the UE to support a data channel. For example, in the case of an Android system, HTML content included in the data channel application may be displayed on a screen through Native Web engine WebView, and a JavaScript™ code may be executed. The DCUI may interwork with the data channel server through an API provided by the data channel layer 770 to acquire the data channel application through the bootstrap data channel and establish an additional data channel for the data channel application.

Herein, the UE may acquire the data channel application from one or more data channel application providers. A data channel stream ID of the bootstrap data channel may be mapped to the data channel application provider. For example, a data channel stream ID “0” may be mapped to a network provider (for example, a local network provider) in which a UE is registered, a data channel stream ID “10” may be mapped to a subscriber of the network provider (for example, a local user who is a local network user) in which the UE is registered, a data channel stream ID “100” may be mapped to a remote network provider (for example, the IMS 680), and a data channel stream ID “110” may be mapped to a subscriber of the remote network provider (for example, a remote user who is a remote network user). The mapped may be described based on one UE.

Herein, the UE may acquire the data channel application through one or more DCMFs.

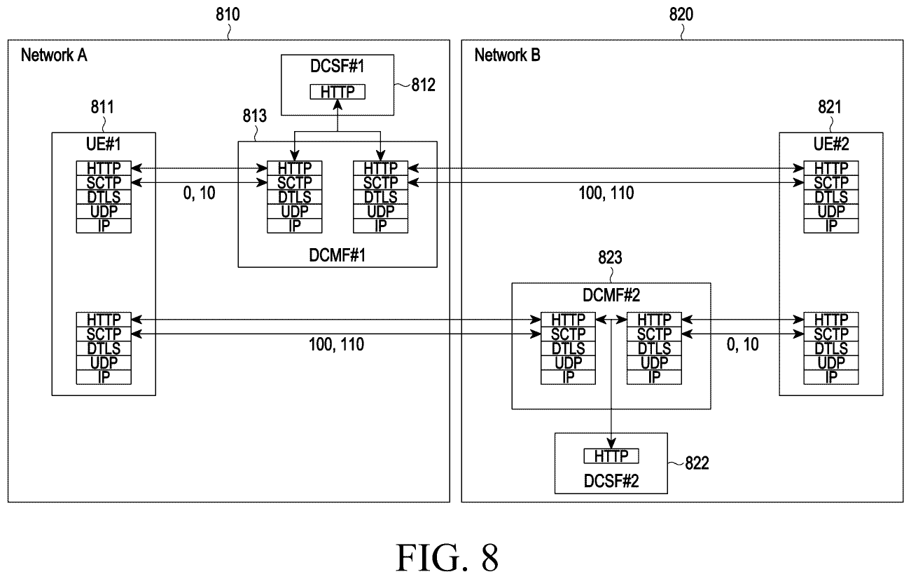

FIG. 8 illustrates a media plane structure including bootstrap data channels provided by two DCMFs in a communication system according to an embodiment.

Referring to FIG. 8, a first DCMF (DCMF #1) 813 located in a network A 810 may provide an HTTP proxy function for a first DSCF (DSCF #1) 812. The DCMF #1 813 may provide a first UE (UE #1) 811 and a second UE (UE #2) 821 with two bootstrap data channels of which data channel application providers are a network A 810 provider and a network A 810 subscriber. Since DCMF #1 813 and the first UE 811 are located in network A 810, a stream ID of the bootstrap data channel for acquiring data channel application provided by network A 810 provider may be configured as “0”, and a stream ID of the bootstrap data channel for acquiring a data channel application provided by the network A subscriber may be configured as “10”. However, since network A 810 in which DCMF #1 813 is located corresponds to a remote network from a viewpoint of the second UE 821 located in network B 820, a stream ID of the bootstrap data channel for acquiring the data channel application provided by the network A 810 provider may be configured as “100”, and a stream ID of the bootstrap data channel for acquiring the data channel application provided by network A subscriber may be configured as “110”.

Similarly, a second DCMF (DCMF #2) 823 located in network B 820 different from network A 810 may provide an HTTP proxy function for a second DCSF (DCSF #2) 822 and provide UE #1 811 and UE #2 821 with two bootstrap data channels of which data channel application providers are a network B 820 provider and a network B subscriber. Since DCMF #2 823 and UE #2 821 are located in network B 820, a stream ID of the bootstrap data channel for acquiring the data channel application provided by the network B 820 provider may be configured as “0”, and a stream ID of the bootstrap data channel for acquiring the data channel application provided by network B 820 subscriber may be configured as “10”. However, since network B 820 in which DCMF #2 823 is located corresponds to a remote network from a viewpoint of the first UE 811 located in network A 810, a stream ID of the bootstrap data channel for the acquiring data channel application provided by the network B 820 provider may be configured as “100”, and a stream ID of the bootstrap data channel for acquiring the data channel application provided by network B subscriber may be configured as “110”.

Referring to FIG. 8, DCMF #1 813 and DCMF #2 823 may be considered as separate devices located in network A 810 and network B 820. In this case, UE #1 811 (or UE #2 821) should separately configure a DTLS session for communication with DCMF #1 813 and a DTLS session for communication with DCMF #2 823. Since a media description (“m=” line) of the SDP may include information for configuring one DTLS session, DTLS session configuration information for communication with DCMF #1 813 may be negotiated as a first media description (first “m=” line), and DTLS session configuration information for communication with DCMF #2 823 may be negotiated as a second description (second “m=” line).

In the communication system herein, the DCMF may support bootstrap data channel multiplexing. The DCMF supporting bootstrap data channel multiplexing may provide the UE with connections to one or more DCMFs by using one DTLS session and a DTLS anchoring function for communication with another DCMF.

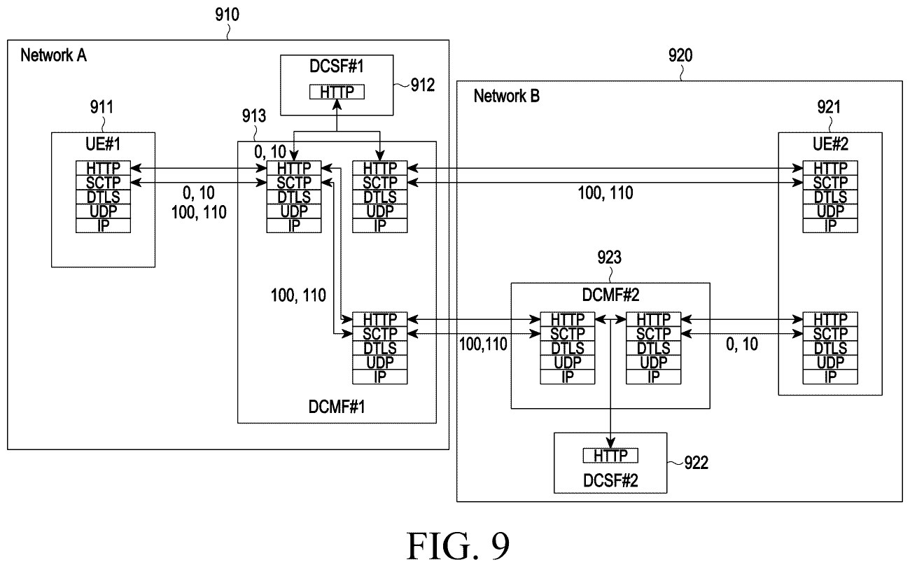

FIG. 9 illustrates a media plane structure in which bootstrap data channels provided by two DCMFs are multiplexed in a communication system according to an embodiment. FIG. 9 illustrates an example in which only one of the two DCMFs supports bootstrap data channel multiplexing.

Referring to FIG. 9, a first UE (UE #1) 911 and a first DCMF (DCMF #1) 913 may be connected through a first DTLS session, and the first DTLS session may include four bootstrap data channels having stream ID values of “0”, “10”, “100”, and “110”. DCMF #1 913 may perform an HTTP proxy function for a first DCSF (DCSF #1) 912 and, to this end, may use two bootstrap data channels having stream ID vales of “0” and “10” of the first DTLS session connected to UE #1 911 and two bootstrap data channels having stream ID values of “100” and “110” of the second DTLS session connected to a second UE (UE #2) 921.

DCMF #1 913 may provide an SCTP association function between DCMF #2 923, which performs the HTTP proxy function for second DCSF (DCSF #2) 922, and UE #1 911. To provide the SCTP association function, DCMF #1 913 and second DCMF (DCMF #2) 923 may be connected through a third DTLS.

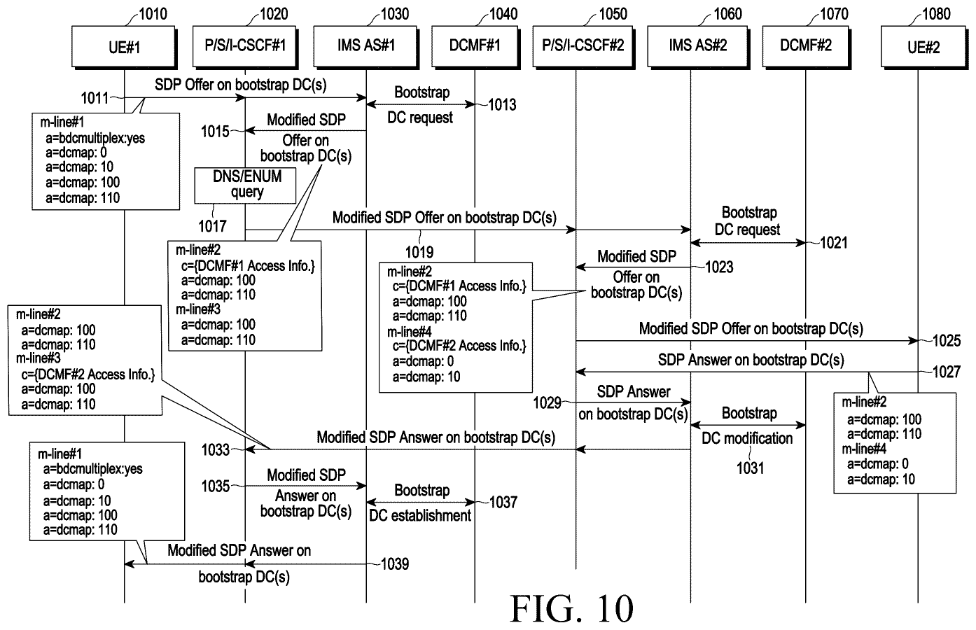

FIG. 10 illustrates a multiplexed bootstrap data channel establishment procedure in a communication system according to an embodiment. In FIG. 10, it is assumed that a first UE (UE #1) 1010, a first P/S/I-CSCF (P/S/I-CSCF #1) 1020, a first IMS AS (IMS AS #1) 1030, and a first DCMF (DCMF #1) 1040 are located in a first network, and a second P/S/I-CSCF (P/S/I-CSCF #2) 1050, a second IMS AS (IMS AS #2) 1060, a second DCMF (DCMF #2) 1070, and a second UE (UE #2) 1080 are located in a second network different from the first network.

Referring to FIG. 10, the UE may establish multiplexed bootstrap data channels and acquire a data channel application through the following procedure.

In step 1011, UE #1 1010 transmits an SIP INVITE request message including an SDP offer to IMS AS #1 1030 via P/S/I-CSCF #1 1020. For example, the SDP offer may include a first bootstrap data channel media description (m-line #1) for bootstrap data channel establishment shown in Table 6 below. Among attributes included in Table 6, “b=”line (bandwidth-field) indicates a bandwidth of a data channel, attribute “a=max-message-size:” attribute “a=sctp-port:” attribute “a=setup:” attribute “a=fingerprint:”, and attribute “a=tls-id” are attributes for configuring a user datagram protocol (UDP)/datagram transport layer security (DTLS)/system control transmission protocol (SCTP). The attribute “a=dcmap:” is an attribute for configuring a data channel-related parameter and may include a data channel stream ID (dcmap-stream-id) and an application layer protocol (subprotocol) to be transmitted to a data channel. The data channel stream ID of the bootstrap data channel may be mapped to a data channel application provision entity. The media description in Table 6 may offer all of the four data channel application provision entities. Particularly, the data channel stream IDs “0” and “10” are requests for establishing a bootstrap data channel with DCMF #1 1040, and the data channel stream IDs “100” and “110” are requests for establishing a bootstrap data channel with DCMF #2 1070. The UE participating in the real-time interaction service may further include attribute “a=bdcmultiplexing:” in the SDP offer for bootstrap data channel establishment. The attribute “a-bdcmultiplexing:” is an attribute indicating whether bootstrap data channel multiplexing is supported and may have a value of “yes” as a parameter thereof. The value of “yes” may indicate that the UE or the network device transmitting the SDP including the media description supports bootstrap data channel multiplexing. Based on the attribute “a=bdcmultiplexing”, UE #1 1010 may notify the first network of whether bootstrap data channel multiplexing can be supported and identify whether the first network can support bootstrap data channel multiplexing. Whether to support bootstrap data channel multiplexing may be exchanged through an SIP message or a separate protocol during a process in which UE #1 1010 is registered in the IMS network or a call session establishment process. For example, it may be signaled using a feature-capability indicator or a media feature tag of the SIP message.

```
TABLE 6
  m=application 52718 UDP/DTLS/SCTP webrtc-datachannel
  b=AS:500
  a=max-message-size:1024
  a=sctp-port:5000
  a=setup:actpass
  a=fingerprint:SHA-1
4A:AD:B9:B1:3F:82:18:3B:54:02:12:DF:3E:5D:49:6B:19:E5:7C:AB
  a=tls-id: abc3de65cddef001be82
  a=bdcmultiplexing:“yes”
  a=dcmap:0 subprotocol=“http”
  a=dcmap:10 subprotocol=“http”
  a=dcmap:100 subprotocol=“http”
  a=dcmap:110 subprotocol=“http”
```

In step 1013, IMS AS #1 1030 receiving the SIP INVITE request message analyzes bootstrap data channel media descriptions in the SDP offer and allocates resources for the bootstrap data channels to DCMF #1 1040. IMS AS #1 1030 may acquire information required for allocating the resources from at least one of the HSS and the DCSF, and the information required for allocating the resources may include information indicating whether DCMF #1 1040 supports bootstrap data channel multiplexing.

In step 1015, IMS AS #1 1030 modifies the SDP offer and transmits an SIP INVITE request message including the same to P/S/I-CSCF #1 1020. The modified SDP offer may include the operator policy or the result of allocation of the resources of DCMF #1 1040. Herein, IMS AS #1 1030 may remove the first bootstrap data channel media description (m-line #1) from the SDP offer and add a second bootstrap data channel media description (m-line #2) and a third bootstrap data channel media description (m-line #3). The second bootstrap data channel media description (m-line #2) may include access information of DCMF #1 1040 as an offer for bootstrap data channel establishment between DCMF #1 1040 and UE #2 1080. The third bootstrap data channel media description (m-line #3) may be an offer for providing an SCTP association function with DCMF #2 1070 to UE #1 1010.

When DCMF #1 1040 does not support bootstrap data channel multiplexing, IMS AS #1 1030 may reject the bootstrap data channel establishment request.

In step 1017, P/S/I-CSCF #1 1020 identifies the second network to which UE #2 1080 has subscribed and searches for P/S/I-CSCF #2 1050 to transmit the SIP INVITE request message including the modified SDP offer.

In step 1019, the SIP INVITE request message including the modified SDP offer transmitted by P/S/I-CSCF #1 1020 is transmitted to IMS AS #2 1060 via P/S/I-CSCF #1 1050.

In step 1021, IMS AS #2 1060 receiving the SIP INVITE request message analyzes bootstrap data channel media descriptions in the modified SDP offer and allocates resources for the bootstrap data channels to DCMF #2 1070. IMS AS #2 1060 may acquire information required for allocating the resources from at least one of the HSS and the DCSF, and the information required for allocating the resources may include information indicating whether DCMF #2 1070 supports bootstrap data channel multiplexing. In FIG. 10, it is assumed that at least one of DCMF #2 1070 and UE #2 1080 does not support data channel multiplexing.

In step 1023, IMS AS #2 1060 modifies the SDP offer and transmits an SIP INVITE request message including the modified SDP offer to P/S/I-CSCF #2 1050. The modified SDP offer may include the operator policy or the resource allocation result of DCMF #2 1070. IMS AS #2 1060 may remove the third bootstrap data channel media description (m-line #3) from the SDP offer and add a fourth bootstrap data channel media description (m-line #4). The third bootstrap data channel media description (m-line #3) may be an offer for providing an SCTP association with DCMF #2 1070 to UE #1 1010 by DCMF #1 1040, and the fourth bootstrap data channel media description (m-line #4) may be an offer for bootstrap data channel establishment between DCMF #2 1070 and UE #2 1080.

In step 1025, P/S/I-CSCF #2 1050 transmits an SIP INVITE request message including the modified SDP offer received from IMS AS #2 1060 to UE #2 1080.

In step 1027, UE #2 1080 receiving the SIP INVITE request message including the modified SDP offer from P/S/I-CSCF #2 1050 may transmit a 18x response message to P/S/I-CSCF #2 1050. The 18x response message may include an answer to the SDP offer related to the bootstrap data channel (SDP answer). In FIG. 10, it is assumed that UE #2 1080 has agreed with four bootstrap data channel establishment included in the second bootstrap data channel media description (m-line #2) and the fourth bootstrap data channel media description (m-line #4).

In step 1029, P/S/I-CSCF #2 1050 transmits the 18x response message including the SDP offer to IMS AS #2 1060.

In step 1031, IMS ASv 1060 may analyze the SDP answer message, communicate with the remote DCMF #2 1070 as necessary according to the analysis result, and reallocate bootstrap data channel-related resources.

In step 1033, IMS AS #2 1060 modifies the SDP answer and transmits the 18x response message including the same to P/S/I-CSCF #2 1050. The modified SDP answer may include the operator policy or the resource allocation result of DCMF #2 1070. IMS AS #2 1060 may add the third bootstrap data channel media description (m-line #3) to the SDP answer and remove the fourth bootstrap data channel media description (m-line #4). The third bootstrap data channel media description (m-line #3) may be a response for providing an SCTP association function with DCMF #2 1070 to UE #1 1010 by DCMF #1 1040, and the fourth bootstrap data channel media description (m-line #4) may be a response for bootstrap data channel establishment between DCMF #2 1070 and UE #2 1080.

In step 1035, P/S/I-CSCF #2 1020 receiving the 18x response message from IMS AS #2 1060 may transmit an 18x response message including the modified SDP answer received from IMS AS #2 1060 to IMS AS #1 1030.

In step 1037, IMS AS #2 1030 receiving the 18x response message from P/S/I-CSCF #2 1020 may analyze the modified SDP answer included in the received 18x response message, communicate with DCMF #2 1040 as necessary according to the analysis result, and reallocate bootstrap data channel-related resources.

In step 1039, IMS AS #2 1030 modifies the modified SDP answer and transmits an 18x response message including the same to UE #1 1010 via P/S/I-CSCF #1 1020. The modified SDP answer may include the operator policy or the resource allocation result of DCMF #2 1040. IMS AS #1 1030 may add the first bootstrap data channel media description (m-line #1) from the SDP offer to the SDP answer with UE #1 1010 and remove the second bootstrap data channel media description (m-line #2) and the third bootstrap data channel media description (m-line #3). The first bootstrap data channel media description (m-line #1) may be a response to multiplexed bootstrap data channel establishment between UE #1 1010 and DCMF #1 1040. The second bootstrap data channel media description (m-line #2) may be a response to bootstrap data channel establishment between DCMF #1 1040 and UE #2 1080, and the third bootstrap data channel media description (m-line #3) may be a response to bootstrap data channel establishment for providing the SCTP association function with DCMF #2 1070 to UE #1 1010 by DCMF #1 1040.

Thereafter, the remaining call session establishment procedures between UE #1 1010 and UE #2 1080 are performed, and UE #1 1010 and UE #2 1080 may acquire the data channel application through the established bootstrap data channels.

Herein, all of the two DCMFs located in different networks may support bootstrap data channel multiplexing.

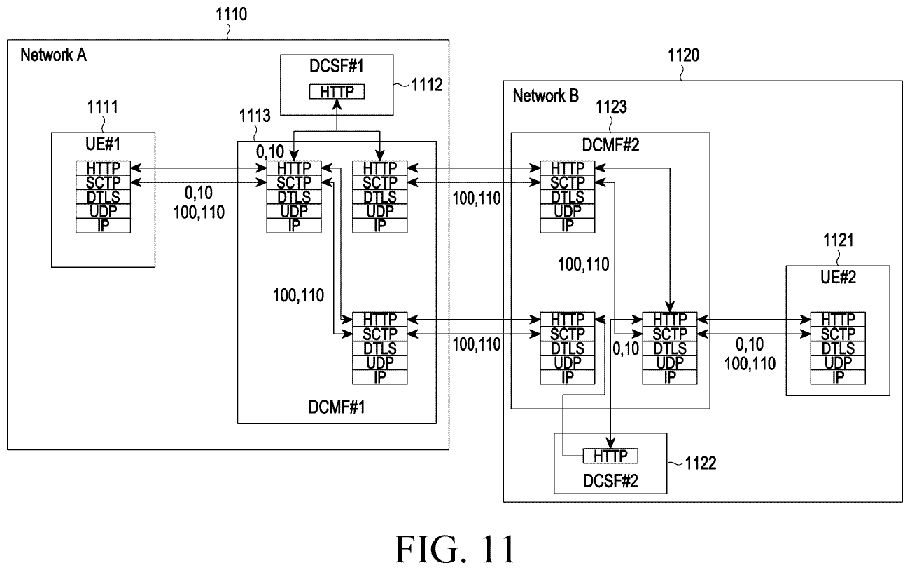

FIG. 11 illustrates a media plane structure provided by two DCMFs supporting bootstrap data channel multiplexing in a communication system according to an embodiment.

Referring to FIG. 11, UE #1 1111 and DCMF #1 1113 may be connected through a first DTLS session, and the first DTLS session may include four bootstrap data channels having stream ID values of “0”, “10”, “100”, and “110”. DCMF #1 1113 may perform an HTTP proxy function for DCSF #1 1112 and, to this end, may use two bootstrap data channels having stream ID vales of “0” and “10” of the first DTLS session connected to UE #1 1111 and two bootstrap data channels having stream ID values of “100” and “110” of the second DTLS session connected to DCMF #2 1123 that provides an SCTP association function with UE #2 1121.

DCMF #1 1113 may provide an SCTP association function between DCMF #2 1123 performing the HTTP proxy function for DCSF #2 1122 and UE #1 1111. To provide the SCTP association function, DCMF #1 1113 and DCMF #2 1123 may be connected through a third DTLS.

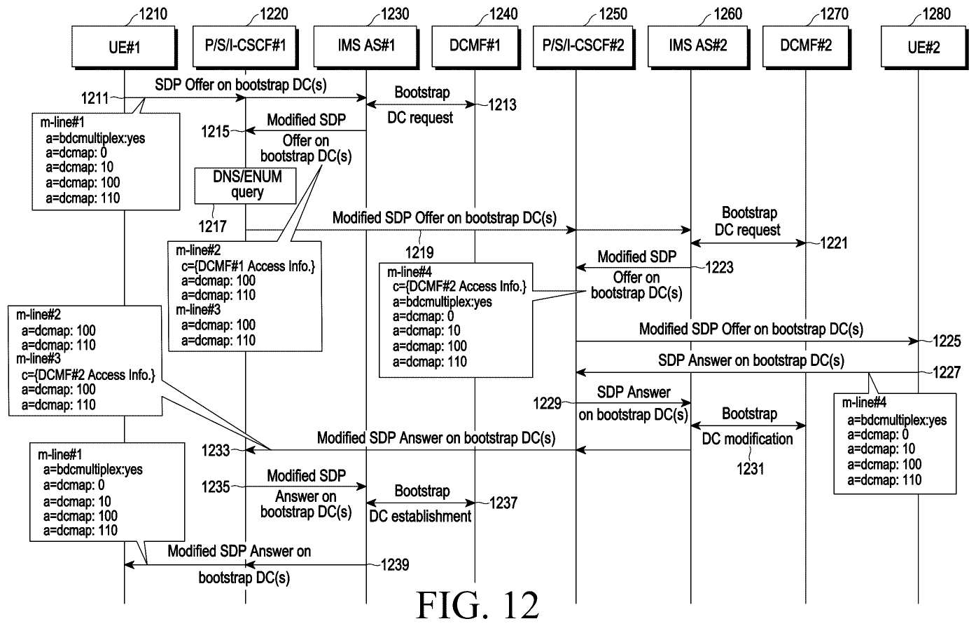

FIG. 12 illustrates a procedure of establishing two bootstrap data channels multiplexed in a communication system according to an embodiment. In FIG. 12, similar to the embodiment of FIG. 10, it is assumed that a UE #1 1210, P/S/I-CSCF #1 1220, IMS AS #1 1230, and DCMF #1 1240 are located in a first network, and P/S/I-CSCF #2 1250, IMS AS #2 1260, DCMF #2 1270, and UE #2 1280 are located in a second network different from the first network.

Referring to FIG. 12, the UE may establish multiplexed bootstrap data channels and acquire a data channel application through the following procedure.

Steps 1211 to 1219 are identical to steps 1011 to 1019 in FIG. 10.

In step 1221, IMS AS #2 1260 receiving the SIP INVITE request message analyzes bootstrap data channel media descriptions in the modified SDP offer and allocates resources for the bootstrap data channels to DCMF #2 1270. IMS AS #2 1260 may acquire information required for allocating the resources from at least one of the HSS and the DCSF, and the information required for allocating the resources may include information indicating whether DCMF #2 1270 supports bootstrap data channel multiplexing. In FIG. 12, it is assumed that both DCMF #2 1270 and UE #2 1280 support data channel multiplexing.

In step 1223, IMS AS #2 1260 modifies the SDP offer and transmits an SIP INVITE request message including the same to P/S/I-CSCF #2 1250. The SDP offer modification (or modified SDP offer) may include the operator policy or the resource allocation result of DCMF #2 1270. The IMS AS #2 1260 may remote a second bootstrap data channel media description (m-line #2) and a third bootstrap data channel media description (m-line #3) from the SDP offer and add a fourth bootstrap data channel media description (m-line #4). The second bootstrap data channel media description (m-line #2) may be an offer for providing an SCTP association function with DCMF #1 1240 to UE #2 1280 by DCMF #2 1270, and the third bootstrap data channel media description (m-line #3) may be an offer for providing an SCTP association function with DCMF #2 1270 to UE #1 1210 by DCMF #1 1240. The fourth bootstrap data channel media description (m-line #4) may be an offer for bootstrap data channel establishment between DCMF #2 1270 and UE #2 1280 and may include access information of DCMF #2 1270.

In step 1225, P/S/I-CSCF #2 1250 transmits an SIP INVITE request message including the modified SDP offer received from IMS AS #2 1260 to UE #2 1280.

In step 1227, UE #2 1280 receiving the SIP INVITE request message including the modified SDP offer from P/S/I-CSCF #2 1250 may transmit a 18x response message to P/S/I-CSCF #2 1250. The 18x response message may include an answer to the SDP offer related to the bootstrap data channel (SDP answer). In FIG. 12, it is assumed that UE #2 1280 has agreed with four bootstrap data channel establishment included in a four media description (m-line #4).

Steps 1229 to 1239 are identical to steps 1029 to 1039 in FIG. 10.

Thereafter, the remaining call session establishment procedures between UE #1 1210 and UE #2 1280 are performed, and UE #1 1210 and UE #2 1280 may acquire the data channel application through the established bootstrap data channels.

Accordingly, a bootstrap data channel and an application data channel may be multiplexed through one SCTP association in the communication system.

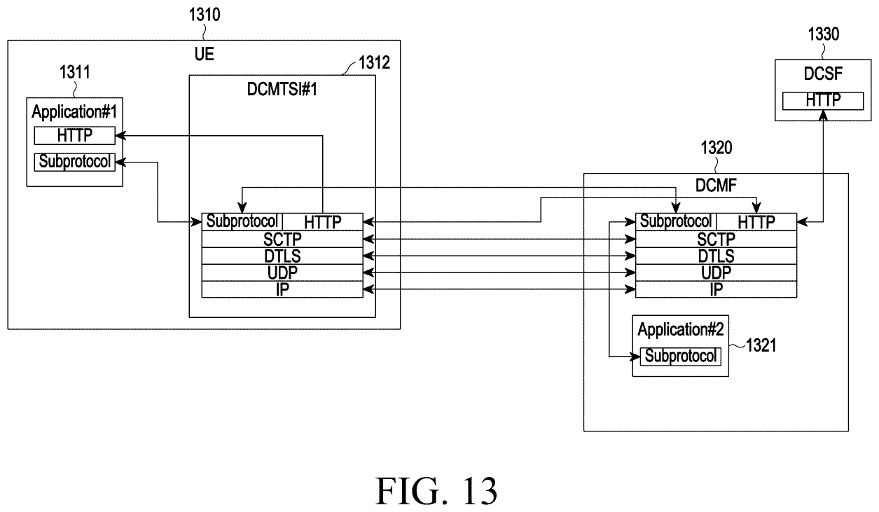

FIG. 13 illustrates a media plane structure in which a bootstrap data channel and an application data channel are multiplexed in a communication system according to an embodiment.

Referring to FIG. 13, a UE 1310 may include a first application (application #1) 1311 acquired through a bootstrap data channel and a DCMTSI client 1312 for providing a data channel. The DCMTSI client 1312 is a multimedia telephony service for a data channel (DC) IMS (MTSI) device supporting a data channel and may be a device that complies with the relevant standard. A DCMF 1320 may include a protocol stack that matches a data channel protocol stack of the DCMTSI client 1312, and a second application (application #2) 1321 corresponding to the first application 1311. The second application 1321 may provide one service with the first application 1311, provide all or some of the functions provided by the first application 1311, and additionally provide functions which the first application 1321 does not provide. Although FIG. 13 illustrates that the DCMF 1320 provides the second application 1321, the second application 1321 may be provided by a separate network device or a second UE.

Whether to support multiplexing of the bootstrap data channel and the application data channel may be exchanged through an SIP message or a separate protocol during a process in which the first UE 1310 is registered in the IMS network or a call session establishment process. For example, the channel to be supported may be signaled using a feature-capability indicator or a media feature tag of the SIP message.

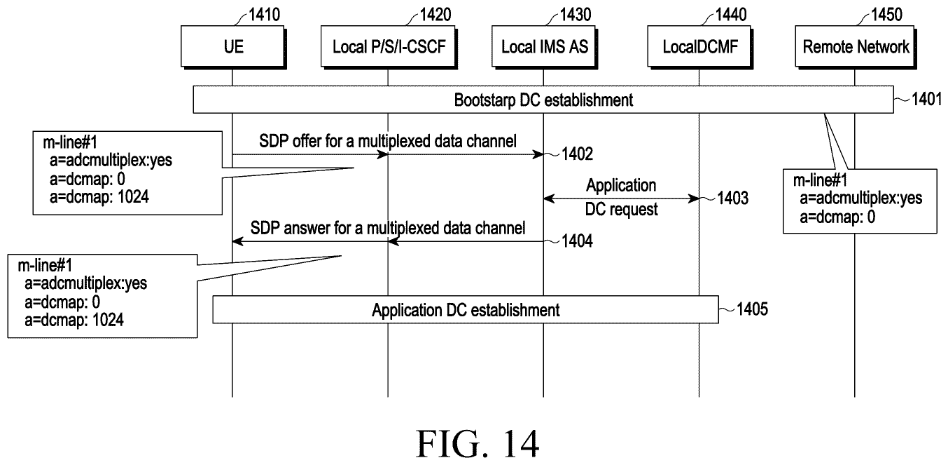

FIG. 14 illustrates a procedure of establishing an application data channel multiplexed with a bootstrap data channel in a communication system according to an embodiment. In FIG. 14, it is assumed that a local DCMF 1440, a local IMS AS 1430, and a local DCMF 1440 are located in a local network to which a UE 1410 has subscribed, and the local network is a network different from a remote network 1450.

Referring to FIG. 14, the UE 1410 may establish an application data channel multiplexed with a bootstrap data channel through the following procedure.

In step 1401, the UE 1410 establishes a bootstrap DCDC having a bootstrap DC stream ID value of “0” with the local DCMF 1440 and acquires a first data channel application through the established bootstrap DC. A first bootstrap DC media description (m-line #1) for establishing the bootstrap DC or an SDP offer and an answer including the first bootstrap DC media description (m-line #1) may include attributes indicating whether multiplexing of the bootstrap DC and the application data channel is supported. In FIG. 14, the first bootstrap DC media description (m-line #1) may include attribute “a=adcmultiplexing”, and when a value of the attribute “a=adcmultiplexing” is configured as “yes”, it may indicate that a bootstrap DC including the attribute “a=adcmultiplexing” can be multiplexed with an application data channel.

In step 1402, the UE 1410 transfers an SIP RE-INVITE request message including an application data channel establishment request for the operation of a first data channel application to a local IMS AS 1430 via a local P/S/I-CSCF 1420. The SIP RE-INVITE request message may include an SDP offer, and a first bootstrap DC media description (m-line #1) in the SDP offer may include attribute “a=dcmap” that proposes establishment of an application data channel having a stream ID value of 1024.

In step 1403, the local IMS AS 1430 receiving the SIP RE-INVITE request message analyzes the data channel media descriptions in the SDP offer and allocates resources for the application data channel to a local DCMF 1440. The local IMS AS 1430 may acquire information required for allocating the resources from at least one of the HSS and the DCSF, and the information required for allocating the resources may include information indicating whether the local DCMF 1440 supports bootstrap DC multiplexing. In FIG. 14, it is assumed that the local DCMF 1440 and the UE 1410 support multiplexing of the bootstrap DC and the application data channel.

In step 1404, the local IMS AS 1430 transmits an SDP answer to the SDP offer to the UE 1410 through a local P/S/I-CSCF 1420. The SDP answer may be acquired through a different procedure depending on a location of a second data channel application corresponding to the first data channel application. As in FIG. 13, when the DCMF provides the second data channel application, the local IMS AS 1430 may generate an SDP answer by using information provided by at least one network entity among a local DCSF, the local DCMF 1440, and an HSS. When the second data channel application is provided by a second network entity, not by the local DCMF 1440, the local DCMF 1440 may provide the UE 1401 with an SCTP association function with the second network entity. An additional SIP message exchange and SDP offer/response process for acquiring the SDP answer may be performed. The second network entity may include a second UE.

In step 1405, the first channel application of the UE 1410 may communicate with the second channel application by using the application data channel established through multiplexing with the existing bootstrap DC.

The above-described embodiments describe the case where bootstrap DC multiplexing-related information is provided as lower attribute (for example, attribute “a=bdcmultiplexing” or attribute “a=adcmultiplexing”) of the media description including bootstrap DC configuration information. Whether to support the application channel multiplexing function may be signaled through other methods according to implementation. For example, whether to support application channel multiplexing may be signaled through at least one of an SDP and an SIP message at a real-time communication service session level. For example, the SDP may include the attribute “a=bdcmultiplexing” or the attribute “a=adcmultiplexing” as an attribute of the session level, not a lower attribute of a specific media description. In another example, the SIP message may include a code corresponding to an attribute value of “bdcmultiplexing” or “adcmultiplexing” as a +sip.app-subtype media feature tag or a feature-capability indicator.

Accordingly, the application data channel in the communication system may be established between a first UE and a second UE or between the first UE and a first server, and application data channels having different ends may be multiplexed through one SCTP association from a viewpoint of the first UE. This is referred to as ATDE multiplexing.

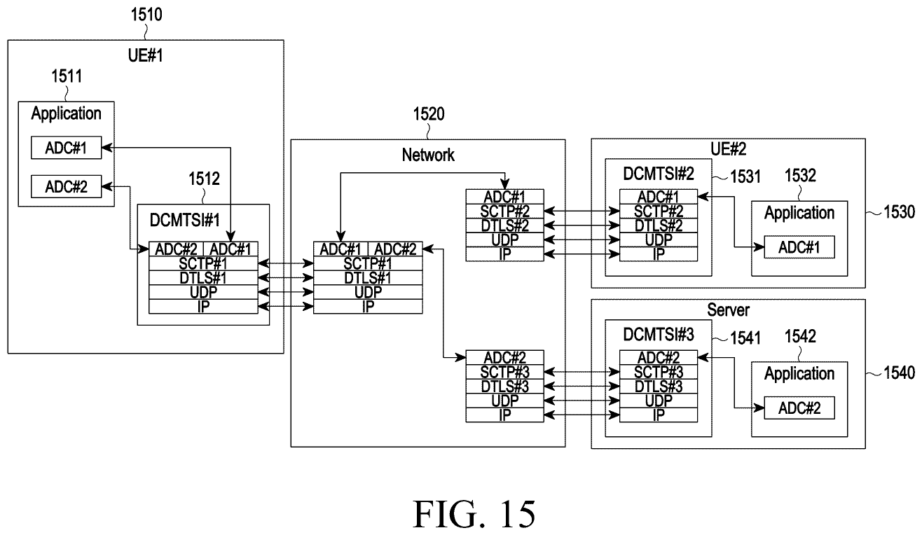

FIG. 15 illustrates a media plane structure supporting ATDE multiplexing in a communication system according to an embodiment.

Referring to FIG. 15, a first UE 1510 may include a first application 1511 acquired through the bootstrap DC and a first DCMTSI client 1512 for providing a data channel. The first DCMTSI client 1512 is a multimedia telephony service for IMS (MTSI) device supporting a data channel and may be a device that complies with all or some of the relevant standard. A network 1520 may include a protocol stack that matches a data channel protocol stack of the first DCMTSI client 1512 and may be an IMS access gateway (IMS-AGW) or a DCMF. Similar to the first UE 1510, a second UE 1530 may include a first application 1532 acquired through the bootstrap DC and a second DCMTSI client 1531 for providing a data channel. A server 1540 may include a third application 1542 and a third DCMTSI client 1541 for providing a data channel, and the third application 1542 and the third DCMTSI client 1541 may be implemented as separate devices. The first application 1511, the second application 1532, and the third application 1542 may provide one service, and may include all or some of the functions for providing the one service according to selection of a service provider.

A first SCTP association established between the network 1520 and the first UE 1510 may include one or more application data channels, and the application data channels may have different endpoints. For example, a first application data channel (ADC #1) may include data to be exchanged between the first application 1511 and the second application 1532, and a second application data channel (ADC #2) may include data to be exchanged between the first application 1511 and the third application 1542. The network 1520 may establish a second SCTP association with the second UE 1530 to exchange data of ADC #1. Similarly, the network 1520 may establish a third SCTP association with the server 1540 to exchange data of ADC #2.

The network 1520 and the server 1540 may be integrated into one device or separately implemented as more detailed devices, and the existence or nonexistence of the third SCTP association may depend on an implementation method. For example, the IMS-AGW may perform the function of the network 1520 and the DCMF may perform the function of the server 1540, in which case the IMS-AGW and the DCMF may establish the third SCTP association to exchange data. In another example, the DCMF may perform the function of the network 1520 and the server 1540, in which case the third SCTP association may be replaced with an interface within the device. The third application 1542 may exchange data of the second application data channel with the network 1520 by using another application protocol, in which case the third SCTP association may be replaced with a protocol stack according to an application protocol used by the second application 1531.

Whether to support ATDE multiplexing may be exchanged through an SIP message or a separate protocol during a process in which the UE 1310 is registered in the IMS network or a call session establishment process. For example, ATDE multiplexing may be signaled using a feature-capability indicator or a media feature tag of the SIP message or signaled as an attribute of the SDP included in the SIP message.

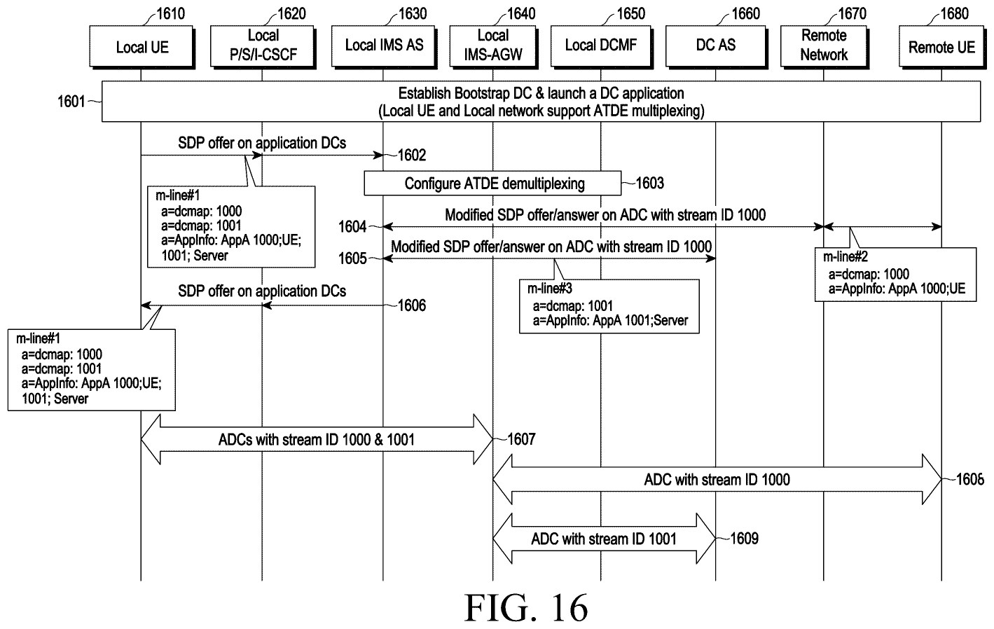

FIG. 16 illustrates an application data channel establishment and data exchange procedure to which ATDE multiplexing is applied in a communication system according to an embodiment. In FIG. 16, it is assumed that a local IMS AS 1630, a local IMS-AGW 1640, and a local DCMF 1650 are located in a local network to which a local UE 1610 has subscribed, and the local network is a network different from a remote network 1670. It is assumed that the local IMS-AGW 1640 provides the function of the network 1520 in FIG. 15, the local DCMF 1650 provides the function of the third DCMTSCI client 1541 of the server 1540 in FIG. 15, and the DC AS 1660 provides the function of the third application 1542 in FIG. 15.

Referring to FIG. 16, the local UE 1610 may establish an application data channel to which ATDE multiplexing is applied to exchange data through the following procedure.

In step 1601 the local UE 1610 and a remote UE 1680 establish a bootstrap DC with a local DCMF 1650, acquire a data channel application (AppA) through the bootstrap DC, and execute the data channel application. It is assumed that supporting of ATDE multiplexing by the local UE 1610 and a local network during the process is identified.

In step 1602, the local UE 1610 transfers an SDP offer for establishing an application data channel to a local IMS AS 1630 via a local P/S/I-CSCF 1620. For example, a first media description (m-line #1) in the SDP offer may include a first application data channel having a stream ID value of 1000 and a second application data channel having a stream ID value of 1001. The first media description (m-line #1) may include attribute “a=AppInfo” indicating that the data channel application (AppA) acquired in step 1601 makes a request for the first application data channel (Stream ID=1000) to be established with the remote UE 1680 and the second application data (Stream ID=1001) to be established with the DC AS 1660.

In step 1603, the local IMS AS 1630 receiving the SDP offer allocates resources for supporting ATDE multiplexing to the local IMS-AGW 1640 and the local DCMF 1650. The local IMS AS 1630 may collect information required for resource allocation from another network function. Communication with the local IMS-AGW 1640 and the local DCMF 1650 for resource allocation may be performed through another network function.

In step 1604, the local IMS AS 1630 performs an SDP offer/answer procedure for establishing the first application data channel (Stream ID=1000) between the local IMS-AGW 1640 and the remote UE 1680. The SDP for the SDP offer/answer procedure may include a second media description (m-line #2) that provides information for establishing a second SCTP association between the local IMS-AGW 1640 and the remote UE 1680. A signaling transmission path for performing the SDP offer/answer procedure may include another network function located in the remote network 1670, and the other network function may be involved in the SDP offer/answer procedure. For example, a procedure for the ATDE multiplexing function of the remote network 1670 may be performed.
In step 1605, the local IMS AS 1630 and the DC AS 1660 perform an SDP offer/answer procedure for establishing the second application data channel (Stream ID=1001) between the local IMS-AGW 1640 and the DC AS 1660. The SDP for the SDP offer/answer procedure may include a third media description (m-line #3) that provides information for establishing a third SCTP association between the local IMS-AGW 1640 and the local DCMF 1650. Another network function may be located in a signaling transmission path for performing the SDP offer/answer procedure, and the local IMS AS 1630 and the DC AS 1660 may acquire information for making the SDP offer/answer from the other network function.

In step 1606, the local IMS AS 1630 transfers an SDP answer to the SDP offer provided by the local UE 1610 in step 1602 to the local UE 1610, based on the second media description (m-line #2) and the third media description (m-line #3) negotiated in step 1604 and operation 1605. Resources of the local IMS-AGW 1640 or the local DCMF 1650 may be controlled according to the negotiation result of the second media description (m-line #2) and the third media description (m-line #3).

In step 1607, the local UE 1610 establishes the first SCTP association with the local IMS-AGW 1640, based on the negotiation result of the first media description (m-line #1), and exchanges data through the first application data channel (Stream ID=1000) and the second application data channel (Stream ID=1001).

In step 1608, the local IMS-AGW 1640 establishes the second SCTP association with the remote UE 1680, based on the negotiation result of the second media description (m-line #2), and exchanges data through the first application data channel (Stream ID=1000).

In step 1609, the local IMS-AGW 1640 establishes the third SCTP association with the DC AS 1660, based on the negotiation result of the third media description (m-line #3), and exchanges data through the second application data channel (Stream ID=1001).

The above-described procedure is a signaling and application data channel data exchange procedure between the local UE 1610, and the local network and the DC AS 1660 when the local UE 1610 and the local network use ATDE multiplexing and may be applied to when the remote network 1670 and the remote UE 1680 use the ATDE. When the use of ATDE multiplexing is not agreed between the UE and the network, the UE should make a request for establishing an application data channel by using a different media description (m-line) for each endpoint. For example, the SDP offer in step 1602 may be configured as follows.

```
m-line#1
  a = dcmap: 1000
  a = AppInfo: AppA 1000;UE
m-line#1
  a = dcmap: 1001
  a = AppInfo: AppA 1001;Server
```

In FIG. 16, the bootstrap establishment procedure (operation 1601) may include a process of negotiating whether to support ATDE multiplexing using the SDP. For example, a media description including information on the bootstrap DC may include attribute “a=atdemultiplexing”.

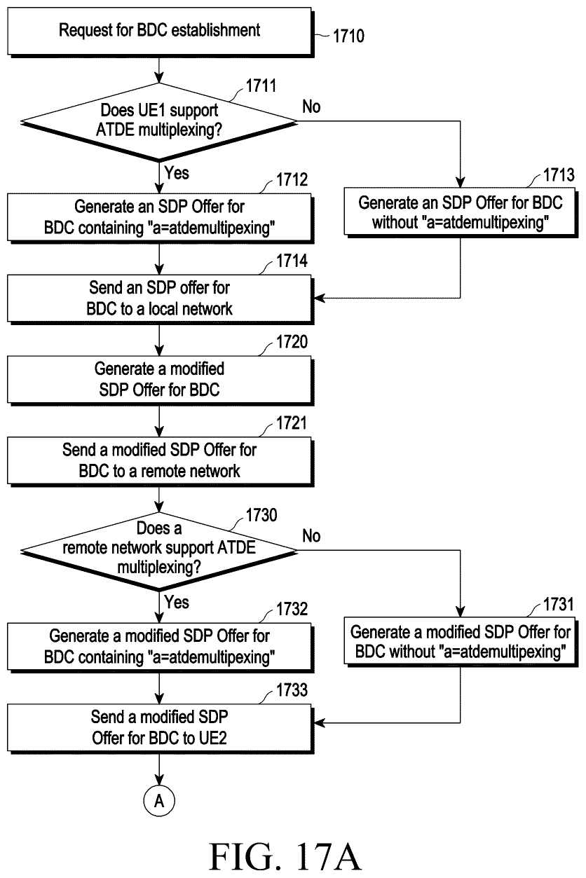

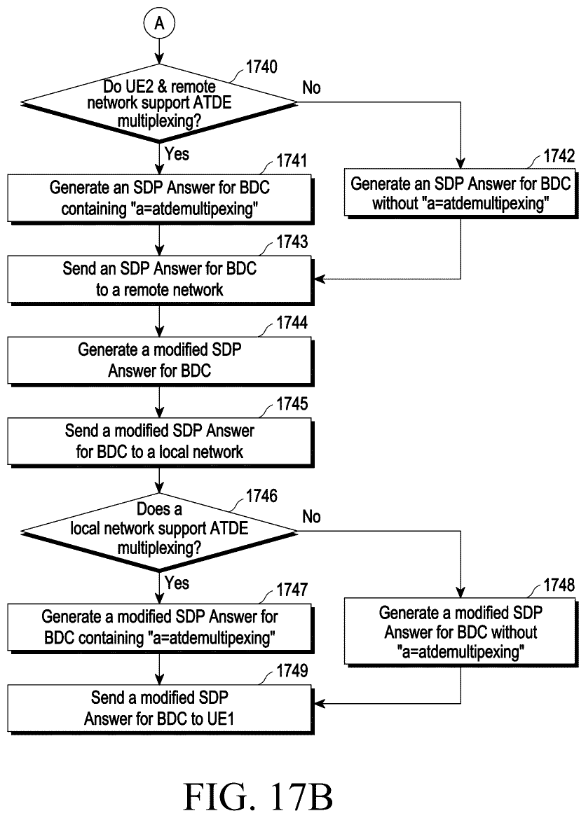

FIGS. 17A and 17B illustrate negotiation indicating whether to support ATDE multiplexing using the SDP in a communication system according to an embodiment.

Referring to FIGS. 17A and 17B, steps 1710 to 1714 indicate a process in which the local UE 1610 transmits an SDP offer for establishing a bootstrap DC (BDC) to the remote network.

In step 1710, the local UE 1610 initiates a bootstrap DC establishment procedure for acquiring a data channel application.

In step 1711, operation 1712 is performed when the local UE 1610 supports ATDE multiplexing, and operation 1713 is performed when the local UE 1610 does not support the same.

In step 1712, the local UE 1610 generates an SDP offer including a first media description for establishing a bootstrap DC. the first media description may include attribute “a=atdemultiplexing”.

In step 1713, the local UE 1610 generates an SDP offer including a first media description for establishing a bootstrap DC. The first media description does not include attribute “a=atdemultiplexing”.

In step 1714, the local UE 1610 transfers the generated SDP offer to the local network.

Steps 1720 to 1721 indicate a process in which the local network processes the received SDP offer and transmits the SDP offer to the remote network 1670.

In step 1720, the local network processes the received SDP offer and generates a modified SDP offer. When the local UE 1610 and the local network support ATDE multiplexing, the SDP offer processing procedure may include resource allocation for supporting ATDE multiplexing.

In step 1721, the local network transfers the modified SDP offer generated in step 1720 to the remote network 1670.

Steps 1730 to 1733 indicate a process in which the remote network 1670 processes the received modified SDP offer and transmits the SDP offer to the remote UE 1680

In step 1730, it is determined whether the remote network 1670 supports ATDE multiplexing. Step 1731 is performed when the remote network 1670 supports ATDE multiplexing, and step 1732 is performed when the remote network 1670 does not support ATDE multiplexing.

In step 1731, the remote network 1670 processes the received SDP offer and generates the modified SDP offer including a second media description for establishing a bootstrap DC. The second media description may include attribute “a=atdemultiplexing”. The SDP offer processing process may include resource allocation for supporting ATDE multiplexing.

In step 1732, the remote network 1670 processes the received SDP offer and generates the modified SDP offer including a second media description for establishing a bootstrap DC. The second media description does not include attribute “a=atdemultiplexing”.

In step 1733, the remote network 1670 transfers the generated modified SDP offer to the remote UE 1680.

Steps 1740 to 1743 indicate a process in which the remote UE 1680 transmits an SDP answer for establishing a bootstrap DC (BDC) to the remote network 1670.

In step 1740, it is determined whether the remote UE 1680 and remote network 1670 support ATDE multiplexing. Step 1741 is performed when the remote UE 1680 and the remote network 1670 support ATDE multiplexing, and step 1742 is performed when the remote UE 1680 and the remote network 1670 do not support ATDE multiplexing. Whether the remote network 1670 supports ATDE multiplexing may be determined according to whether the received modified SDP offer includes the attribute “a=atdemultiplexing”.

In step 1741, the remote UE 1680 generates an SDP answer including a second media description for establishing a bootstrap DC. The second media description may include attribute “a=atdemultiplexing”.

In step 1742, the remote UE 1680 generates an SDP answer including a second media description for establishing a bootstrap DC. The second media description does not include attribute “a=atdemultiplexing”.

In step 1743, the remote UE 1680 transfers the generated SDP answer to the remote network 1670.

Steps 1744 to 1749 indicate a process in which the remote network 1670 processes the received SDP answer and transmits the SDP answer to the local network.

In step 1744, the remote network 1670 processes the received SDP answer and generates a modified SDP answer. When the remote network 1670 supports ATDE multiplexing, the SDP answer processing process may include resource allocation for supporting ATDE multiplexing.

In step 1745, the remote network 1670 transfers the modified SDP answer generated in step 1744 to the local network.

Steps 1746 to 1749 indicate a process in which the local network processes the received modified SDP answer and transmits the SDP answer to the local UE 1610.

In step 1746, it is determined whether the local network supports ATDE multiplexing. Step 1747 is performed when the local network supports ATDE multiplexing, and step 1748 is performed when the local network does not support ATDE multiplexing.

In step 1747, the local network processes the received modified SDP answer and generates a modified SDP answer including a first media description for establishing a bootstrap DC of the local UE 1610. The first media description may include attribute “a=atdemultiplexing”. The modified SDP answer processing process may include resource allocation for supporting ATDE multiplexing.

In step 1748, the local network processes the received modified SDP answer and generates a modified SDP answer including a first media description for establishing a bootstrap DC of the local UE 1610. The first media description does not include attribute “a=atdemultiplexing”.

In step 1749, the local network transfers the generated modified SDP answer to the local UE 1610.

In the communication system herein, the client transmits a request for a root URL (“/”) to the data channel server through the bootstrap DC to acquire a data channel application. The data channel server receiving the request for the root URL may select a data channel application according to a data channel application selection reference and provide the selected data channel application. The data channel application selection reference may include the bootstrap DC multiplexing-related information.

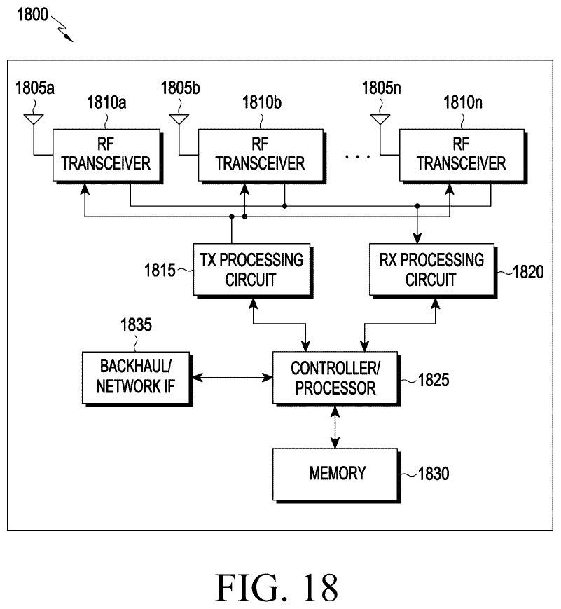

FIG. 18 illustrates an internal structure of a network entity in a wireless communication system according to an embodiment.

An internal structure of a network entity 1800 illustrated in FIG. 18 is only an example, and the internal structure of the network entity 1800 may vary.

Referring to FIG. 18, the network entity 1800 includes a plurality of antennas 1805a to 1805n, a plurality of radio frequency (RF) transceivers 1810a to 1810n, a transmit (TX) processing circuit 1815, and a receive (RX) processing circuit 1820. The network entity 1800 also includes a controller/processor 1825, memory 1830, and a backhaul or network interface (IF) 1835.

The RF transceivers 1810a to 1810n receive, from the antennas 1805a to 1805n, input RF signals, such as signals transmitted by UEs in a wireless communication network. The RF transceivers 1810a to 1810n generate IF or baseband signals by down-converting the input RF signals. The IF or baseband signals are transmitted to the RX processing circuit 1820, and the RX processing circuit 1820 generates processed baseband signals by filtering, decoding, and/or digitalizing the baseband or IF signals. The RX processing circuit 1820 transmits the processed baseband signals to the controller/processor 1825 for additional processing.

The TX processing circuit 1815 receives analog or digital data (such as voice data, web data, email, or interactive video game data) from the controller/processor 1825. The TX processing circuit 1815 generates processed baseband or IF signals by encoding, multiplexing, and/or digitalizing the output baseband data. The RF transceivers 1810a to 1810n receive the output processed baseband or IF signals from the TX processing circuit 1815 and up-convert the baseband or IF signals into RF signals transmitted through the antennas 1805a to 1805n.

The controller/processor 1825 may include one or more processors or other processing devices for controlling the overall operation of the network entity 1800. The network entity 1800 may be one of the various network entities (for example, the IMS AS, the IMS HSS, the data channel server, the DC application server, and the like) described in FIGS. 1 to 14. The overall operation of the network entity 1800 may be implemented to be similar to or substantially the same as that described in FIGS. 1 to 17, and accordingly a detailed description thereof is omitted.

For example, the controller/processor 1825 may control reception of forward channel signals and transmission of backward channel signals by the RF transceivers 1810a to 1810n, the RX processing circuit 1820, and the TX processing circuit 1815 according to the well-known principles. The controller/processor 1825 may support additional functions such as more advanced wireless communication functions. For example, one of the various other functions may be supported by the controller/processor 1825 in the network entity 1800. The controller/processor 1825 may include at least one microprocessor or microcontroller. The controller/processor 1825 may be implemented as at least one processor and may be referred to as a “processor”.

The controller/processor 1825 may execute programs and other processes residing in the memory 1830, such as an OS. The controller/processor 1825 may move data required by the executed process to the memory 1830 or the outside of the memory 1830. The controller/processor 1825 may support communication between network entities. The controller/processor 1825 may move data to the memory 1830 or the outside of the memory 1830 according to the executed process.

The controller/processor 1825 is connected to the backhaul or network IF 1835. The backhaul or network IF 1835 allows the network entity 1800 to communicate with other devices or systems through the backhaul communication or the network. The backhaul or network IF 1835 may support communication through a random suitable wired or wireless communication(s). For example, when the network entity 1800 is implemented as a portion of the cellular communication system (such as the cellular communication system supporting 5G NR, long-term evolution (LTE), or long-term evolution-advanced (LTE-A)), the backhaul or network IF 1835 may allow the network entity 1800 to communicate with other network entities through the wired or wireless backhaul communication. When the network entity 1800 is implemented as an access point, the backhaul or network IF 1835 may allow the network entity 1800 to perform communication through a wired or wireless local area communication network or through a larger network (such as the Internet) via a wired or wireless connection. The backhaul or network IF 1835 includes an appropriate structure supporting communication through the wired or wireless connection such as an Ethernet or an RF transceiver.

Although FIG. 18 illustrates an example of the network entity 1800, various modifications can be made in FIG. 18. For example, the network entity 1 150 may include a predetermined number of components illustrated in FIG. 11. For example, the access point may include a plurality of backhaul or network interfaces 1835, and the controller/processor 1825 may support routing functions that route data between different network addresses. In addition, although a single instance of the TX processing circuit 1815 and a single instance of the RX processing circuit 1820 are illustrated, the network entity 1800 may include a plurality of instances (such as one instance per RF transceiver). Further, in FIG. 18, various components may be combined, may be additionally divided, or may be omitted, and additional components may be added according to specific needs.

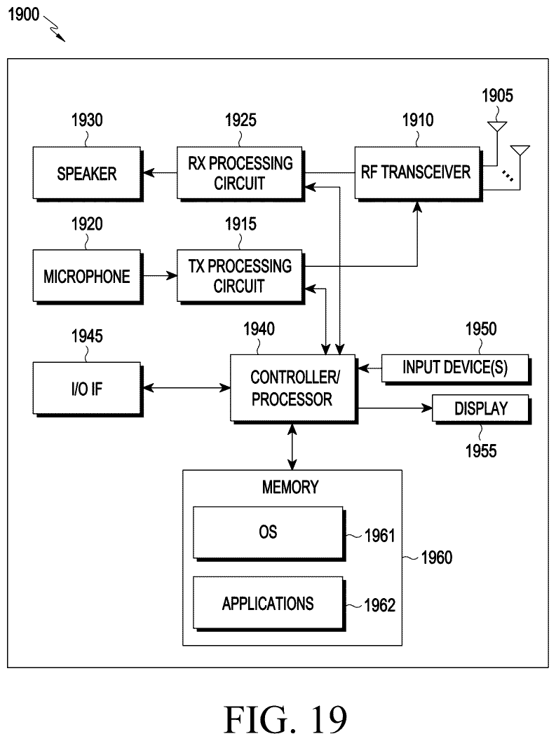

FIG. 19 illustrates an internal structure of a UE in a wireless communication system according to an embodiment.

An internal structure of a UE 1900 illustrated in FIG. 19 is only an example, and the internal structure of the UE 1900 may not be limited to implementation illustrated in FIG. 19.

Referring to FIG. 19, the UE 1900 includes an antenna 1905, a radio frequency (RF) transceiver 1910, a TX processing circuit 1915, a microphone 1920, and an RX processing circuit 1925. The UE 1900 also includes a speaker 1930, a controller/processor 1940, an input/output (I/O) IF 1945, an input device 1950, a display 1955, and memory 1960. The memory 1960 includes an operating system (OS) 1961 and one or more applications 1962.

The RF transceiver 1910 receives an input RF signal transmitted by a network entity of the wireless communication network from the antenna 1905. The RF transceiver 1910 down-converts the input RF signal to generate an intermediate frequency or baseband signal. The intermediate frequency or baseband signal is transmitted to the RX processing circuit 1925, and the RX processing circuit 1925 generates a processed baseband signal by filtering, decoding, and/or digitalizing the baseband or intermediate frequency signal. The RX processing circuit 1925 transmits the processed baseband signal to the speaker 1930 (for voice data) or the processor 1940 (for web browsing data) for additional processing.

The TX processing circuit 1915 receives analog or digital voice data from the microphone 1920 or receive different output baseband data (such as web data, email, or interactive video game data) from the processor 1940. The TX processing circuit 1915 generates a processed baseband or intermediate frequency signal by encoding, multiplexing, and/or digitalizing the output baseband data. The RF transceiver 1910 receives the output processed baseband or intermediate frequency signal from the TX processing circuit 1915 and up-converts the baseband or intermediate frequency signal into an RF signal transmitted through the antenna 1905.

The controller/processor 1940 may include one or more processors or other processing devices, and execute the OS 1961 stored in the memory 1960 to control the overall operation of the UE 1900. The operation of the UE 1900 may be implemented to be similar to or substantially the same as that described in FIGS. 1 to 17, and accordingly, a description thereof is omitted herein. For example, the controller/processor 1940 may control reception of forward channel signals and transmission of backward channel signals by the RF transceiver 1910, the RX processing circuit 1925 and the TX processing circuit 1915 according to the known principles. The controller/processor 1940 includes at least one microprocessor or micro-controller.

The controller/processor 1940 may also execute other processes and programs in the memory 1960, such as processes for beam management. The controller/processor 1940 may move data to the memory 1960 or from the memory 1960 when required by the executed processor. The processor 1940 may be configured to execute the applications 1962, based on the OS program 1961 or in response to signals received from network entities or an operator. The controller/processor 1940 is connected to the I/O IF 1945, and the I/O IF 1945 provides the UE 1900 with connection capability for other devices such as laptop computers and handheld computers. The I/O IF 1945 is a communication path between accessories and the processor 1940.

The controller/processor 1940 is also connected to the input device 1950 and the display unit 1955. The operator of the UE 1900 may input data into the UE 1900 by using the input device 1950. The input device 1950 may be another device capable of acting as a user interface that allows a keyboard, a touch screen, a mouse, a track ball, a voice input, or a user to interact with the UE 1900. In another example, the input device 1950 may include a touch panel, a (digital) pen sensor, a key, or an ultrasound input device. The touch panel may recognize a touch input through at least one of a capacitive type, a resistive type, an infrared type, or an ultrasound type.

The controller/processor 1940 is also connected to the display 1955. The display 1955 may be a liquid crystal display, an organic light emitting diode display, or another display capable of at least rendering text and/or limited graphics from web sites.

The memory 1960 is connected to the processor 1940. A part of the memory 1960 may include random access memory (RAM), and the remaining parts of the memory 1960 may include flash memory or other read-only memory (ROM).

Although FIG. 19 illustrates an example of the UE 1900, various modifications can be mode in FIG. 19. For example, in FIG. 19, various components may be combined, may be additionally divided, or may be omitted, or other components may be added according to specific needs. As a specific example, the controller/processor 1940 may be divided into a plurality of processors such as one or more central processing units (CPUs) and one or more graphics processing units (GPUs). The controller/processor 1940 may be implemented as at least one processor and may be referred to as a “processor”. Although FIG. 19 illustrates that the UE 1900 includes a mobile phone or a smartphone, UEs may be configured to operate as other types of mobile or stationary devices.

The electronic device which implements, operates, and performs embodiments of the disclosure may be one of various types of electronic devices, including but not limited to a portable communication device (e.g., a smart phone), a computer device, a portable multimedia device, a portable medical device, a camera, a wearable device, or a home appliance.

As used herein, the term module may include a unit implemented in hardware, software, or firmware, and may be interchangeably used with other terms logic, logic block, component, or circuit. The module may be a single integrated component, or a minimum unit or part thereof, adapted to perform one or more functions. For example, The module may be implemented in the form of an application-specific integrated circuit (ASIC).

Various embodiments as set forth herein may be implemented as software (e.g., a program) including one or more instructions that are stored in a storage medium (e.g., an internal memory or external memory) that is readable by a machine (e.g., an electronic device). For example, a processor of the machine (e.g., an electronic device) may invoke at least one of the one or more instructions stored in the storage medium and execute it. This allows the machine to be operated to perform at least one function according to the at least one instruction invoked. The one or more instructions each may include a code generated by a compiler or a code executable by an interpreter. The machine-readable storage medium may be provided in the form of a non-transitory storage medium. The term non-transitory indicates that the storage medium is a tangible device, and does not include a signal or differentiate between where data is semi-permanently or temporarily stored in the storage medium.

A method according to an embodiment may be included and provided in a computer program product traded between a seller and a buyer. The computer program product may be distributed in the form of a machine-readable storage medium (e.g., compact disc read only memory (CD-ROM)), or may be downloaded or uploaded online via an application store (e.g., Play Store™), or directly between two user devices. If distributed online, at least part of the computer program product may be temporarily generated or at least temporarily stored in the machine-readable storage medium, such as memory of the manufacturer's server, a server of the application store, or a relay server.

Herein, each element (e.g., module or program) of the above-described elements may include a single entity or multiple entities, and some of the multiple entities may be separately disposed in another element. One or more of the above-described elements or operations may be omitted, or one or more other elements or operations may be added. Alternatively or additionally, a plurality of modules or programs may be integrated into a single element. In such a case, the integrated element may still perform one or more functions of each of the plurality of elements in the same or similar manner as they are performed by a corresponding one of the plurality of elements before the integration. Operations performed by the module, the program, or another clement may be carried out sequentially, in parallel, repeatedly, or heuristically, or one or more of the operations may be executed in a different order or omitted, or one or more other operations may be added.

Herein, each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create indicates for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction indicates that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Each block of the flowchart illustrations may represent a module, segment, or portion of code, which includes one or more executable instructions for implementing the specified logical function(s). In some alternative implementations, the functions noted in the blocks may occur out of order. For example, two blocks shown in succession may in fact be executed substantially concurrently or the blocks may sometimes be executed in the reverse order, depending upon the functionality involved.

While the disclosure has been illustrated and described with reference to various embodiments of the present disclosure, those skilled in the art will understand that various changes can be made in form and detail without departing from the spirit and scope of the present disclosure as defined by the appended claims and their equivalents.

What is claimed is:

1. A method of a user equipment (UE) in a wireless communication system, the method comprising:
transmitting, to a network entity, a first message comprising a session description protocol (SDP) offer; and
receiving, from the network entity, a second message comprising an SDP answer corresponding to the SDP offer,
wherein the SDP offer comprises a data channel stream identifier of at least one bootstrap data channel and a first attribute related to data channel multiplexing, and
wherein the SDP answer comprises access information of the network entity and the first attribute.

2. The method of claim 1,
wherein the first attribute included in the SDP offer has an attribute value indicating that the UE supports the data channel multiplexing.

3. The method of claim 1,
wherein the first attribute included in the SDP answer has an attribute value indicating that the network entity supports the data channel multiplexing.

4. The method of claim 1,
wherein the UE has a stream control transmission protocol (SCTP) association with another network entity than the network entity.

5. The method of claim 4,
wherein, for the SCTP association, the network entity and the another network entity are connected through a datagram transport layer security (DTLS) session.

6. A method of a network entity in a wireless communication system, the method comprising:
receiving, from a user equipment (UE), a first message comprising a session description protocol (SDP) offer; and
transmitting, to the UE, a second message comprising an SDP answer corresponding to the SDP offer,
wherein the SDP offer comprises a data channel stream identifier of at least one bootstrap data channel and a first attribute related to data channel multiplexing, and
wherein the SDP answer comprises access information of the network entity and the first attribute.

7. The method of claim 6,
wherein the first attribute included in the SDP offer has an attribute value indicating that the UE supports the data channel multiplexing.

8. The method of claim 6,
wherein the first attribute included in the SDP answer has an attribute value indicating that the network entity supports the data channel multiplexing.

9. The method of claim 6,
wherein the network entity supports a stream control transmission protocol (SCTP) association between the UE and another network entity.

10. The method of claim 9,
wherein, for the SCTP association, the network entity is connected with the another network entity through a datagram transport layer security (DTLS) session.

11. A user equipment (UE) in a wireless communication system, the UE comprising:
a transceiver; and
at least one processor connected to the transceiver and configured to:
transmit, to a network entity, a first message comprising a session description protocol (SDP) offer through the transceiver; and
receive, from the network entity, a second message comprising an SDP answer corresponding to the SDP offer,
wherein the SDP offer comprises a data channel stream identifier of at least one bootstrap data channel and a first attribute related to data channel multiplexing, and
wherein the SDP answer comprises access information of the network entity and the first attribute.

12. The UE of claim 11,
wherein the first attribute included in the SDP offer has an attribute value indicating that the UE supports the data channel multiplexing.

13. The UE of claim 11,
wherein the first attribute included in the SDP answer has an attribute value indicating that the network entity supports the data channel multiplexing.

14. The UE of claim 11,
wherein the UE has a stream control transmission protocol (SCTP) association with another network entity than the network entity.

15. The UE of claim 14,
wherein, for the SCTP association, the network entity and the another network entity are connected through a datagram transport layer security (DTLS) session.

16. A network entity in a wireless communication system, the network entity comprising:
a transceiver; and
at least one processor connected to the transceiver and configured to:
receive, from a user equipment (UE), a first message comprising a session description protocol (SDP) offer through the transceiver; and
transmit, to the UE, a second message comprising an SDP answer corresponding to the SDP offer,
wherein the SDP offer comprises a data channel stream identifier of at least one bootstrap data channel and a first attribute related to data channel multiplexing, and
wherein the SDP answer comprises access information of the network entity and the first attribute.

17. The network entity of claim 16,
wherein the first attribute included in the SDP offer has an attribute value indicating that the UE supports the data channel multiplexing.

18. The network entity of claim 16,
wherein the first attribute included in the SDP answer has an attribute value indicating that the network entity supports the data channel multiplexing.

19. The network entity of claim 16,
wherein the at least one processor is configured to support a stream control transmission protocol (SCTP) association between the UE and another network entity.

20. The network entity of claim 19,
wherein, for the SCTP association, the at least one processor is configured to be connected with the another network entity through a datagram transport layer security (DTLS) session.
